(19) United States
(12) Patent Application Publication
(10) Pub. No.: US 2010/0244405 A1
(43) Pub. Date: Sep. 30, 2010

(54) Light Transport Vehicle

(76) Inventor: Imad Assaf, Calgary (CA)

Correspondence Address: McGeehan Technology Law, Ltd., P.O. Box 810, Chicago, IL, 60690-0810, US

(21) Appl. No.: 12/743,229

(22) PCT Filed: Nov. 27, 2008
(86) PCT No.: PCT/CA08/02103

§ 371 Date: May 14, 2010

Related U.S. Application Data
(60) Provisional application No. 60/991,225, filed on Nov. 30, 2007.

(51) Int. Cl. B60D 1/14; B62B 7/06; B60G 9/00; B60D 1/58

(52) U.S. Cl. 280/415.1; 280/651; 280/124.1; 280/727

(57) ABSTRACT

The invention provides a light transport vehicle useful for transporting children and cargo. The transport vehicle may be used as a bicycle trailer, a stroller, a jogger, a sled or other configuration and may be convertible therebetween. The transport vehicle comprising: a folding mechanism allowing the transport vehicle to easily folds into compact size, a hitch for connecting to a bicycle, an adjustable suspension system for a smoother ride for the occupants and cargo, and an attachment receiver to accept conversion attachments.

### RELATED APPLICATIONS

This application claims the benefit of priority to PCT application PCT/CA2008/002103, filed Nov. 27, 2008 which claims the benefit of priority to U.S. provisional application 60/991,225 filed Nov. 30, 2007.

### FIELD OF THE INVENTION

The invention relates to a light transport vehicle convertible to a bicycle trailer, a jogger, a stroller, a sled or other configurations that is useful for transporting children, animals and/or cargo. More specifically, the invention provides an improved transport vehicle with an attachment receiver to accept conversion attachments, a hitch for connecting to a bicycle and an adjustable suspension system for a smoother ride for the occupant and/or cargo.

### BACKGROUND OF THE INVENTION

Joggers, strollers and bicycle trailers are well known light transport vehicles (LTV) used for transporting small children, animals and/or cargo. Besides offering durability, function and safety, the LTV is preferably easily folded to a smaller size for storage, be easily unfolded, be convertible between possible uses, and be readily and securely connected to a bicycle to provide for a smooth ride to the occupant and/or cargo.

While many LTVs are known, there continues to be a need for systems with improved features such as fewer parts, a more stable structure in both folded and unfolded configurations, that requires less effort to collapse or erect and can be more readily converted between different configurations such as a bicycle trailer, jogger, stroller, etc.

More specifically, there has been a need for an LTV that includes:
a. an improved folding system that is easier to use while maintaining a strong and compact structure;
b. an improved attachment receiver that can accept different conversion attachments;
c. an improved hitch; and,
d. an adjustable suspension system,
   all of which individually and collectively improve safety, performance and/or comfort to the user/cargo/occupants of the LTV.

A review of the prior art shows that such improvements to LTVs have not been provided. For example, U.S. Pat. No. 5,577,746 (Britton) discloses a folding transport vehicle as shown in FIGS. 1a, 1b and 1c. The trailer has folding frame unit with a first end and an opposite end. The first end pivots directly on a predetermined axis through the upper frame which allows for only one degree of movement freedom, rotational, for the first end relative to the upper frame. The opposite end pivots directly on a predetermined axis through the lower chassis which allows for only one degree of movement freedom, rotational, for the opposite end relative to the lower chassis. An intermediate pivot point on the folding frame unit allows the first end to pivot in relation to the opposite end. The collapsing and extending of the Britton transport vehicle is feasible only when the axes through the three pivot connections, of each folding frame unit, are substantially parallel to each other and substantially parallel to the axis through the pivot connection between the upper frame and the lower chassis. This limits the collapse direction of the folding frame unit toward the front of the vehicle or to extend behind the vehicle (perpendicular to the axis of rotation).

As a result, there has been a need for an LTV frame with the following objectives:
a. a strong structure for safety and durability;
b. an easy collapsing and extending function, and preferably single-action/handed execution;
c. a compact collapsed size for handling and storage;
d. stable collapsed configuration for handling; and,
e. a large occupant and cargo compartment.

Achieving the preceding objectives has been a challenge. In the LTV disclosed by Britton, a cross member has to extend between the folding frame units to provide for a strong structure and single-action folding. Extending the collapsed folding frame units behind the vehicle increases the collapsed size of the vehicle significantly. Extending the collapsed folding frame unit toward the front of the vehicle reduces the usable width of the vehicle that can be utilized for the interior compartment, and may cause interference with the vehicle's cover or seat. As shown in FIG. 1c, the folding frame units are collapsed toward the front of the vehicle, and the cross member (extending between the folding frame units) travels far into the vehicle's compartment. While FIG. 1c does not show a vehicle cover or seat, the potential interference is clear. The only remedy for this interference is to eliminate the cross member which yields a weaker structure and a two-action folding procedure, or to move the seat considerably forward which significantly reduces the occupant/cargo compartment. Another disadvantage of an LTV with folding frame units that collapse in the forward direction is that the structure is vulnerable in rear impact accidents (for example, an LTV used as a bicycle trailer that is impacted by a motor vehicle from behind). In addition to the preceding disadvantages, the LTV of FIG. 1c has an unstable folding configuration that tends to extend while handling. As a result, there has been a need for a strong structure that collapses in a single-action; and the support frames fold in a location that does not interfere with the vehicle's cover or seat, thus maximizing the usable compartment space while minimizing the collapsed size. In addition, there has been a need for an LTV having a more stable collapsed configuration for improved handling.

As is known, one use of an LTV is as a bicycle trailer. Bicycle trailers need an attachment mechanism (hitch) for connection to a bicycle. Generally, these hitches are cumbersome to attach/detach to the bicycle; have large dimensions; and/or provide limited degrees of rotational freedom. Some hitches utilize a ball and socket joint for their function. The ball and socket joint enables rotation predominately about a single axis with some forgiveness for misalignment. The disadvantage of most hitches is most apparent when trying to lay down the bicycle while still connected to the LTV, which in most cases is unfeasible; or feasible only at a certain orientation of the LTV in relation to the bicycle. Accordingly, there has been a need for a hitch having compact dimensions, easy to attach/detach to a bicycle, and that provides increased flexibility by enabling rotation about three non-parallel axes.

An adjustable suspension is an important feature of LTVs, especially when transporting children. Generally, existing adjustable suspensions are hard to adjust, and do not provide the required performance. As a result, there has been a need for an adjustable suspension that is easy to adjust and provides the desired performance of a smooth ride.

In another aspect, it is important for LTVs to be readily converted between different configurations such as a bicycle trailer, jogger, stroller, etc. Usually, the attachment requires bolting and/or clamping which is cumbersome and time consuming for the user. As a result, there has been a need for an attachment receiver to quickly and securely accept an attachment member (of some form of a conversion kit). Moreover, an attachment receiver that only utilizes telescoping engagement has many disadvantages including a locking connection. As a result, there has been a need for a strong locking mechanism to withstand the forces trying to pull the attachment member out of the attachment receiver and the need for proper alignment (insertion depth) to guarantee the proper engagement of the locking mechanism. More specifically, there has been a need for an attachment receiver that utilizes a push and twist engagement motion to interlock the attachment member into the attachment receiver where this interlock allows for a simple and secure connection. Still further, there has been a need for light locking mechanism that could be used with an attachment receiver to maintain the attachment member at an operative orientation wherein the light locking mechanism is preferably auto engaging thus reducing the attachment process to merely push and twist action.

### SUMMARY OF THE INVENTION

In accordance with the invention, a transport vehicle is described.

In a first aspect of the invention, a transport vehicle is provided comprising: a vehicle frame having a lower chassis supporting and pivotally connected to an upper frame adjacent first ends of the lower chassis and upper frame respectively, the lower chassis operatively supporting transportation apparatus; first and second connection brackets operatively connected to the upper frame and lower chassis respectively wherein each connection bracket allows movement about at least two non-parallel axes; a support frame operably connected between the first and second connection brackets; the support frame including an upper member and a lower member each having a first member end and a second member end, wherein the first member ends are connected to one another via a folding connector allowing the upper support member to pivot toward the lower support member; and wherein the second members ends are each rotatably and pivotally connected to the upper frame and lower chassis respectively via the connection brackets such that the second member end of the lower member can both rotate about the lower chassis about a first axis and pivot relative to the lower chassis about a second axis and the second member end of the upper member can both rotate about the upper frame about a third axis and pivot relative to the upper frame about a fourth axis, such that the upper frame and lower chassis are displaceable between an extended position and a collapsed position; and the support frame folds in a lateral orientation with respect to the lower chassis and upper frame.

In various embodiments, the second ends of the upper frame and lower chassis are displaceable past one another and/or the folding connector comprises at least one pivot connection.

In another embodiment, a second support frame and folding connector, third and fourth connections brackets and a cross arm are operatively connected to between the first and second support frames.

In another embodiment, the folding connector includes a biasing member for biasing the upper and lower support members to an opening position. In another embodiment each connection bracket includes a ball and socket joint.

In one embodiment, in the collapsed position, the support frame is retained in a location between the second ends of the lower chassis and upper frame and in another embodiment, the rear end of the lower chassis is raised to reduce the distance between the upper frame second end and the lower chassis second end thus reducing the height of the support frame and consequently reducing the collapsed size of the transport vehicle.

In another embodiment, the transport vehicle includes a hitch for operatively connecting a tow bar of the transport vehicle to a bicycle, the hitch enabling rotation of the tow bar about three non-parallel axes in relation to the bicycle; the hitch including: a hitch link including a rear end connectable to the tow bar, a front end formed as a ball and an intermediate portion extending therebetween; a hitch socket formed to retain the ball end of the hitch link, the hitch socket having a front end; a rear end; a slot extending about the rear end; and a first pivot connector, the front end having an opening sized to permit the ball end of the hitch link to pass therethrough and the rear end is formed to retain the ball end of the hitch link, wherein the assembly of the hitch link and the hitch socket enables pivotal movement of the hitch link in relation to the hitch socket about a first and second axes; a bicycle link for attachment to a bicycle frame, the bicycle link including a second pivot connector releasably connectable to the first pivot connector allowing the hitch socket to pivot in relation to the bicycle link about a third axis.

In one embodiment, the tow bar and hitch link rotate, in relation to the bicycle link, about three substantially perpendicular axes without the need to flex the hitch link and, in another embodiment, the first pivot connector and the second pivot connector are connected through a releasable retaining pin.

In another embodiment, the transport vehicle includes an adjustable suspension system having: a suspension body for operative connection to the lower chassis; a pivot arm pivotally connected to the suspension body, the pivot arm having: a first end for connection to the transportation apparatus; a first suspension connector for connection with a main suspension member, the main suspension member having: a pivoting end for pivotal connection to the first suspension connector; and, a sliding end for sliding support and engagement within an adjustment track within the suspension body; the sliding end operatively connected to an adjustment lever on the suspension body for operative movement of the sliding end within the adjustment track; wherein movement of the sliding end within the adjustment track changes the relative angle of the main suspension member with respect to the first suspension connector such that movement of the pivot arm with respect to the suspension body requires a different force depending on the relative angle of the main suspension member with respect to the pivot arm.

In a further embodiment, the pivot arm includes a second suspension connector for engagement with a non-adjustable suspension member operatively connected to the suspension body. In another embodiment, the suspension system includes a connection system for operatively connecting two or more suspension systems together.

In yet a further embodiment, the transport vehicle includes an attachment receiver for attachment to the vehicle frame and for releasably engaging an attachment frame member to the attachment receiver, the attachment receiver including: a body having a vehicle frame attachment system for securing the attachment receiver to the vehicle frame; and, at least one receiver orifice for securing an attachment frame member within the receiver orifice, the receiver orifice having a first interlocking system for receiving an attachment frame member to a first position and wherein twisting at the first position engages and secures a second interlocking system on the attachment frame member with first interlocking system.

In a further embodiment, the first and second interlocking systems enable interconnection of the attachment frame member with the receiver orifice at more than one operative orientation.

In a further aspect of the invention, a transport vehicle hitch is provided for operatively connecting a tow bar of a transport vehicle to a bicycle and enabling rotation of the tow bar about three non-parallel axes in relation to the bicycle; the hitch including: a hitch link including a rear end connectable to the tow bar, a front end formed as a ball and an intermediate portion extending therebetween; a hitch socket formed to retain the ball end of the hitch link, the hitch socket having a front end; a rear end; a slot extending about the rear end; and a first pivot connector, the front end having an opening sized to permit the ball end of the hitch link to pass therethrough and the rear end is formed to retain the ball end of the hitch link, wherein the assembly of the hitch link and the hitch socket enables pivotal movement of the hitch link in relation to the hitch socket about a first and second axes; a bicycle link for attachment to a bicycle frame, the bicycle link including a second pivot connector releasably connectable to the first pivot connector allowing the hitch socket to pivot in relation to the bicycle link about a third axis.

In a further aspect of the invention, an adjustable suspension system for a transport vehicle having a vehicle frame and transportation apparatus is provided, the adjustable suspension system comprising: a suspension body for operative connection to the vehicle frame; a pivot arm pivotally connected to the suspension body, the pivot arm having: a first end for connection to the transportation apparatus; a first suspension connector for connection with a main suspension member, the main suspension member having: a pivoting end for pivotal connection to the first suspension connector; and, a sliding end for sliding support and engagement within an adjustment track within the suspension body; the sliding end operatively connected to an adjustment lever on the suspension body for operative movement of the sliding end within the adjustment track; wherein movement of the sliding end within the adjustment track changes the relative angle of the main suspension member with respect to the first suspension connector such that movement of the pivot arm with respect to the suspension body requires a different force depending on the relative angle of the main suspension member with respect to the pivot arm.

In yet another aspect of the invention, an attachment receiver for a transport vehicle having a vehicle frame is provided, the attachment receiver for attachment to the vehicle frame and for releasably engaging an attachment frame member to the attachment receiver, the attachment receiver including: a body having a vehicle frame attachment system for securing the attachment receiver to the vehicle frame; and, at least one receiver orifice for securing an attachment frame member within the receiver orifice, the receiver orifice having a first interlocking system for receiving an attachment frame member to a first position and wherein twisting at the first position engages and secures a second interlocking system on the attachment frame member with first interlocking system.

### BRIEF DESCRIPTION OF THE DRAWINGS

The invention is described with reference to the drawings in which:

FIGS. 1a, 1b and 1c are views of a folding trailer in accordance with the prior art. FIG. 1a is a perspective view of the trailer in the operative position, FIG. 1b is a side view of the trailer in the operative position and FIG. 1c is a side view of the trailer in the collapsed position.

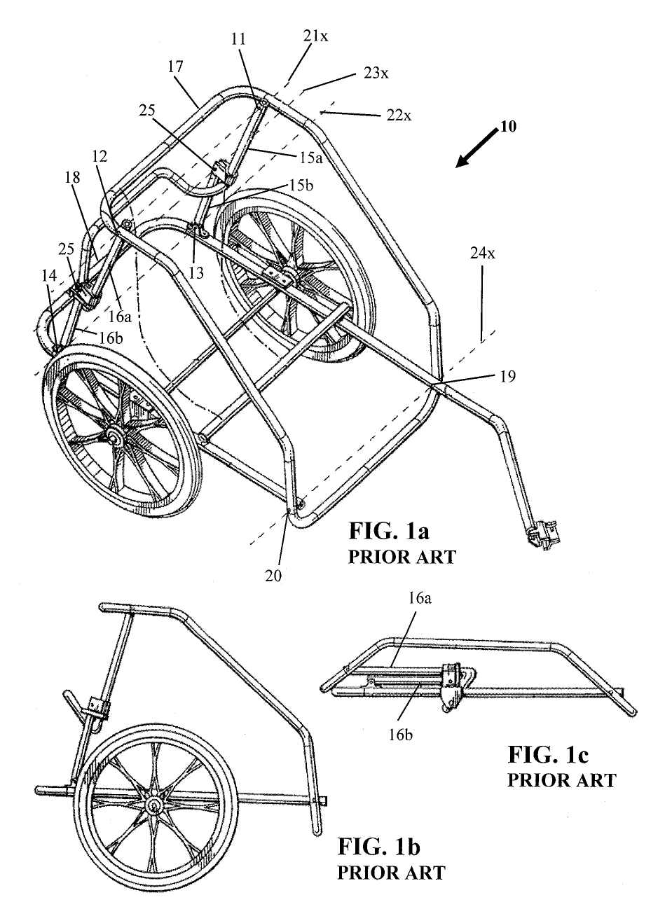

FIGS. 2a, 2b, 2c and 2d are views of an embodiment of a folding vehicle of the present invention. FIG. 2a is a perspective view, FIG. 2b is a side view, FIG. 2c is a top view and FIG. 2d is a back view.

FIG. 3a is a perspective view of a universal joint in accordance with the prior art. FIG. 3b is a perspective view of a universal joint of the present invention and FIG. 3c is a perspective view of a ball joint of the present invention.

FIGS. 4a, 4b, 4c and 4d are views of a folding connector of the present invention. FIG. 4a is a front view in the extended position, FIG. 4b is a perspective view in the extended position, FIG. 4c is a front view in the collapsed position and FIG. 4d is a perspective view in the collapsed position.

FIG. 5 is a perspective view of the vehicle of FIG. 2a in the partially collapsed position.

FIGS. 6a, 6b, 6c and 6d are views of the folding mechanism of the vehicle of FIG. 2a.

FIGS. 7a, 7b, 7c and 7d are views of the vehicle of FIG. 2a in the collapsed compact position. FIG. 7a is a perspective view, FIG. 7b is a side view, FIG. 7c is a back view and FIG. 7d is a top view.

FIG. 8a is a perspective view of a preferred embodiment of a folding vehicle of the present invention. FIGS. 8b, 8c, 8d and 8e are views of the folding mechanism of the vehicle of FIG. 8a.

FIG. 9a is a perspective view of a preferred embodiment of a folding vehicle of the present invention.

FIGS. 9b, 9c and 9d are views of the folding mechanism of the vehicle of FIG. 9a.

FIG. 10 is a perspective view of a preferred embodiment of a folding vehicle of the present invention.

FIGS. 11a, 11b, 11c and 11d are views of a vehicle of the current invention in different function configurations. FIG. 11a is a perspective view of the vehicle of FIG. 10 with the addition of two attachment receivers, tow bar and hitch. The vehicle in FIG. 11a is useable as a bicycle trailer. FIG. 11b is a perspective view of the vehicle of FIG. 10 with the addition of two attachment receivers, one caster receiver, stroller caster assembly and pushing handle assembly. The vehicle in FIG. 11b is useable as a stroller. FIG. 11c is a perspective view of the vehicle of FIG. 10 with the addition of two attachment receivers, two wheel arms, front wheel and pushing handle assembly. The vehicle in FIG. 11c is useable as a jogger stroller. FIG. 11d is a perspective view of an embodiment of a folding vehicle of the present invention with the addition of two attachment receivers, two tow bars and skis. The vehicle in FIG. 11d is useable as a sled.

FIG. 12 is a perspective view of an embodiment of a folding vehicle of the present invention wherein the base frame is substantially formed of a plastic base.

FIG. 13 is an embodiment of a folding vehicle of the present invention with a compartment cover.

FIG. 14 is a perspective view of an embodiment of a hitch of the present invention.

FIG. 15 shows an exploded view of the hitch of FIG. 14, partial tow bar and partial bicycle frame and rear wheel.

FIG. 16a is a perspective view of the hitch of FIG. 14 installed with a quick release axle mechanism onto a bicycle frame. The bicycle frame, with a rear wheel, is partially shown and the front end of a tow bar is shown.

FIGS. 16b, 16c and 16d are top view, front view and side view of FIG. 16a.

FIGS. 17a and 17b are perspective view and front view of the hitch of FIG. 14 installed using a threaded axle and nut onto a bicycle frame. The bicycle frame, with a rear wheel, is partially shown and the front end of a tow bar is shown.

FIGS. 18a, 18b and 18c are a perspective view, front view and exploded view of an embodiment of a suspension system of the present invention.

FIGS. 19a and 19b are front views of the suspension system of FIG. 18a with a cut to show the internal parts. FIG. 19a illustrates the suspension system when no loads or impacts are applied to the suspension system and FIG. 19b illustrates the suspension system of FIG. 19a when a load or impact is applied to suspension system.

FIGS. 20a, 20b and 20c are front views of the suspension system of FIG. 18a with a cut to show the internal parts. FIG. 20a illustrates the system set to the softest adjustment, FIG. 20b illustrates the system set to an intermediate adjustment and FIG. 20c illustrates the system set to the hardest adjustment.

FIG. 21 is a perspective view of the suspension system installed onto a transport vehicle;

FIGS. 22a, 22b and 22c are a perspective view, front view and side view of an attachment anchor.

FIGS. 23a, 23b, 23c and 23d are a perspective view, front view, side view and section view of a preferred embodiment of an attachment receiver.

FIGS. 24a, 24b and 24c are perspective views of an attachment anchor and an attachment receiver through the steps of their engagement.

FIGS. 25a, 25b, 25c and 25d are front view, side view and two section views of an attachment anchor and an attachment receiver when engaged together.

FIGS. 26a and 26b are a perspective view and exploded view of a caster receiver and a stroller caster of the present invention.

### DETAILED DESCRIPTION

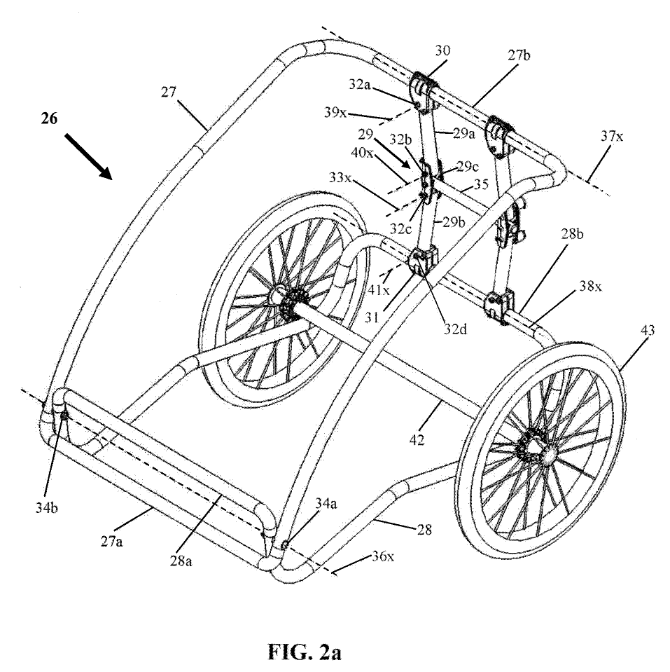

With reference to FIGS. 2-26 an improved LTV with improved sub-systems is described all of which individually and collectively improve safety, performance and/or comfort to the user/cargo/occupants of the LTV.

### Frame Design

FIG. 2a shows a perspective view of an LTV 26 having an upper frame 27, base frame 28, two support frame units 29, two upper connection brackets 30, two lower connection brackets 31 and cross support member 35. The LTV further includes axle 42, secured to base frame 28, for attachment of wheels 43.

Base frame 28 is preferably substantially rectangular in plan view having forward end 28a and rear end 28b. Rear end 28b is higher than the sides of base frame 28. Also, upper frame 27 is preferably substantially rectangular in plan view having forward end 27a and rear end 27b. The upper portion of the trailer's cargo compartment is defined by upper frame 27. Base frame 28 defines the lower portion and rear lower portion of the cargo compartment.

Pivot connections 34a and 34b connect upper frame 27 adjacent its front end 27a to base frame 28 adjacent to its front end 28a. Pivot connections 34a and 34b allow upper frame 27 to rotate in relation to base frame 28 about axis 36x.

Connection bracket 30 allows rotation about two axes that are not parallel (37x and 39x) thus providing a universal joint function. Connection bracket 30 is connected to rear end of upper frame 27b allowing upper frame 27 to rotate about axis 37x. Connection bracket 30 is connected to first support member 29a allowing first support member 29a to rotate about axis 39x. Connection bracket 30 is prevented from moving linearly along axis 37x. Restricting the movement of connection bracket 30 along axis 37x can be accomplished by different ways, for example, by the addition of outside collar or collars (not shown) on rear end 27b of upper frame 27 adjacent to connection bracket 30. Another example is by adding an internal stop feature such as a protrusion in the rear end 27b of upper frame 27 in a location covered by connection bracket 30 and a corresponding internal slot in connection bracket 30. The combination of the protrusion and slot allows for the rotation of connection bracket 30 about the rear end of upper frame 27b and restricts linear motion over the rear end 27b of upper frame 27 along the direction of axis 37x.

Connection bracket 31 allows rotation about two axes that are not parallel (38x and 41x) thus providing a universal joint function. Connection bracket 31 is connected to rear end 28b of base frame 28 allowing base frame 28 to rotate about axis 38x. Connection bracket 31 is connected to opposite support member 29b allowing opposite support member 29b to rotate about axis 41x. Connection bracket 31 is prevented from moving linearly along axis 38x. Restricting the movement of connection bracket 31 along axis 38x can be accomplished in different ways, for example, by the addition of outside collar or collars (not shown) on rear end 28b of base frame 28 adjacent to connection bracket 31. Another example is by adding an internal stop feature such as a protrusion in rear end 28b of base frame 28 in a location covered by connection bracket 31 and a corresponding internal slot in connection bracket 31. The combination of the protrusion and slot allows for the rotation of connection bracket 31 about the rear end 28b of base frame 28 and restricts linear motion over rear end 28b of base frame 28 along the direction of axis 38x.

Support frame unit 29 has first support member 29a, opposite support member 29b and folding connector 29c. First support member 29a and opposite support member 29b are connected to folding connector 29c. Folding connector 29c allows first support member 29a to rotate about axis 40x and folding connector 29c allows opposite support member 29b to rotate about axis 33x. The first support member 29a is connected to connection bracket 30 such that first support member 29a can rotate about axis 39x. The opposite support member 29b is connected to connection bracket 31 such that opposite support member 29b can rotate about axis 41x.

When support frame unit 29 is extended, it maintains the rear end 27b of the upper frame 27 at a predetermined distance from the rear end 28b of base frame 28. This configuration is the preferred operative position of the vehicle.

FIGS. 2b, 2c and 2d show side, top and back views of vehicle 26 of FIG. 2a. FIGS. 2b, 2c and 2d show one folding connector 29c with two openings 44 for a securing pin (not shown). Opening 44 with a corresponding opening in first support member 29a and opposite support member 29b allow for the insertion of securing pins. Securing pins, when inserted through openings 40 and through first support member 29a and opposite support member 29b, locks rotation about axes 33x, 36x, 37x, 38x, 39x, 40x and 41x thus maintaining the vehicle extended in the preferred operative position.

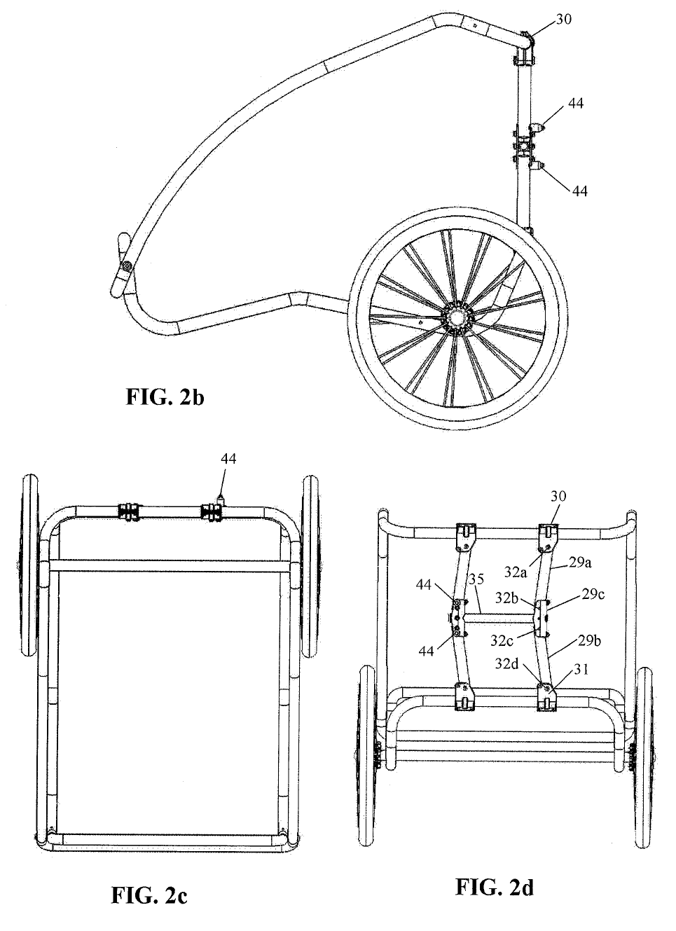

FIG. 3a shows a universal joint known in the art. The axes of rotation are shown on the universal joint of FIG. 3a.

FIG. 3b shows connection bracket 30 with the axes of rotation illustrated. The connection bracket 30 allows for connection to a round surface and simultaneous rotation about that surface.

FIG. 3c shows an alternative to connection bracket 30 of FIG. 3b. The connection bracket of FIG. 3c is a ball joint type. In addition to the flexibility of ball joint movement, it is also capable of rotation about an axis on the connection bracket (shown on FIG. 3c).

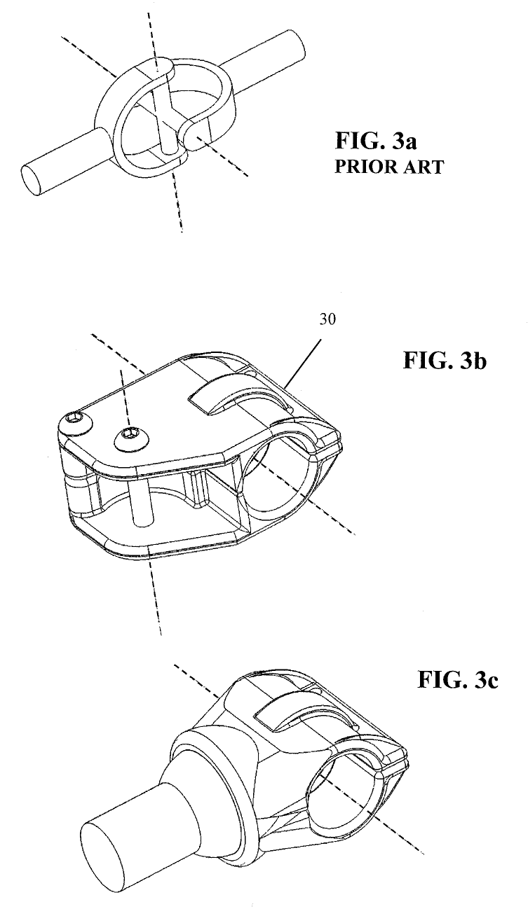

FIGS. 4a, 4b, 4c and 4d are views of a folding connector 600 of the present invention. FIG. 4a is a front view in the extended position, FIG. 4b is a perspective view in the extended position, FIG. 4c is a front view in the collapsed position and FIG. 4d is a perspective view in the collapsed position. FIGS. 4a, 4b, 4c and 4d are shown with partial first support member 601, partial opposite support member 602 and folding connector 600. The folding connector 600 includes a first connector 603 (fixed to first support member 601), opposite connector 604 (fixed to opposite support member 602) and resilient flexible member 605 (connecting first connector 603 and opposite connector 604). In addition, each of the first connector and opposite connector includes contacting surfaces 603a, 603a′ and 604a, 604a′ that provide guidance and protection to the folding connector as it is being folded or un-folded. More specifically, each of the contacting surfaces includes an arcuate edge that is biased towards and engages with a corresponding surface (e.g. 603a and 604a) such that the resilient flexible member 605 is stretched as the connector is folded.

As a result, when folding connector 600 is in the collapsed position, flexed resilient flexible member 605 tries to return toward its un-deformed shape.

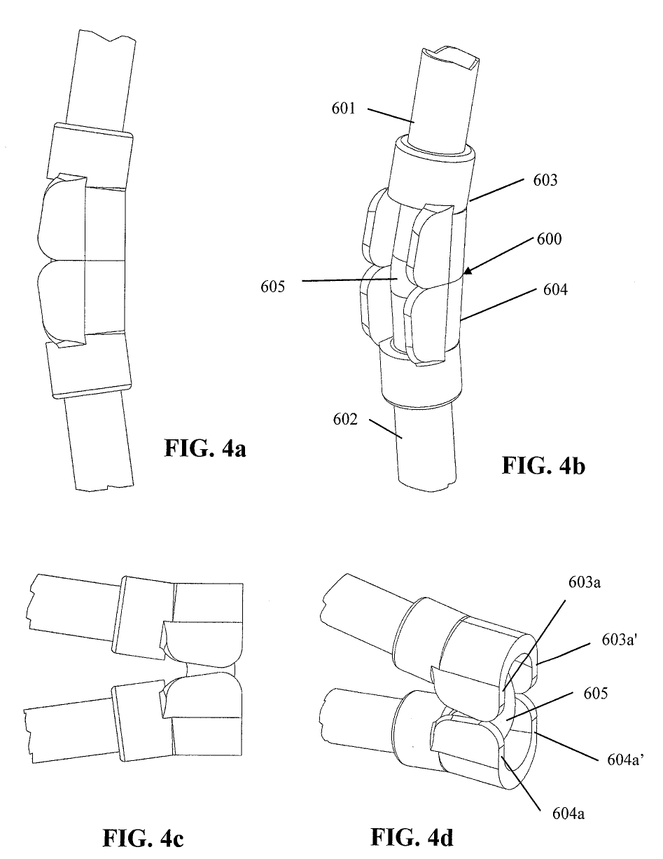

FIG. 5 shows vehicle 26 of FIG. 2a in a partially folded position. Support frame unit 29 folds from an extended position to a collapsed position by rotating first support member 29a about axis 40x (of folding connector 29c), rotating opposite support member 29b about axis 33x (of folding connector 29c), and thereby, rotating first support member 29a (in relation to connection bracket 30) about axis 39x and rotating opposite support member 29b (in relation to connection bracket 31) about axis 41x. As support frame unit 29 is folded from an extended position to a collapsed position, connection bracket 30 rotates about axis 37x, connection bracket 31 rotates about axis 38x and upper frame 27 rotates towards base frame 28 (about axis 36x) and thereby fold vehicle 26 into a compact position. Folding connectors 29c are fixed onto cross support member 35 such that all folding connectors 29c are parallel to each other.

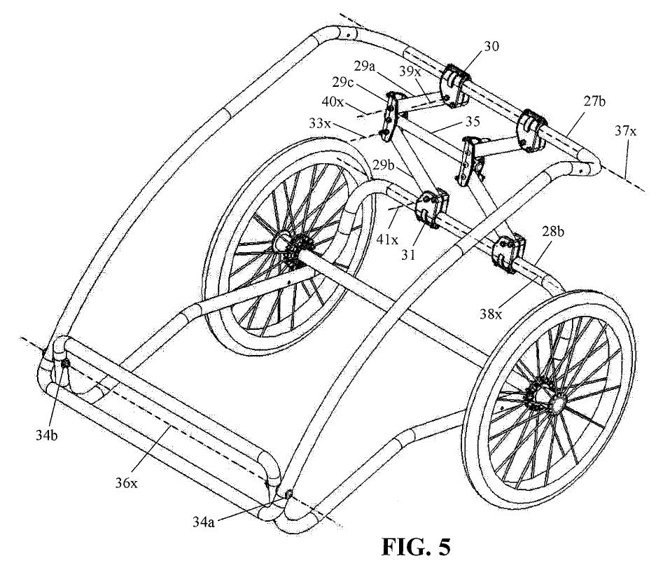

FIGS. 6a, 6b, 6c and 6d show partial perspective views of the back of vehicle 26 of FIG. 2a. FIG. 6a shows the extended position, FIG. 6b shows the start of the collapsing process, FIG. 6c shows a partially collapsed position and FIG. 6d shows the collapsed position where the support members 29a, 29b have been fully pivoted about the frame which, rear end 27b of upper frame 27 has moved past and beneath rear end 28b of base frame 28. As a result, the upper and lower frames more securely in the folded position as two directions of movement are required to move support members 29a, 29b back to the extended position. Furthermore, in the case of a connector 600 being utilized, the resiliently flexible member will have a tendency to bias or lock the frame in the fully folded position until the connectors are pivoted away from the upper and lower frame in which case the connector 600 will have a tendency to assist in opening the frame.

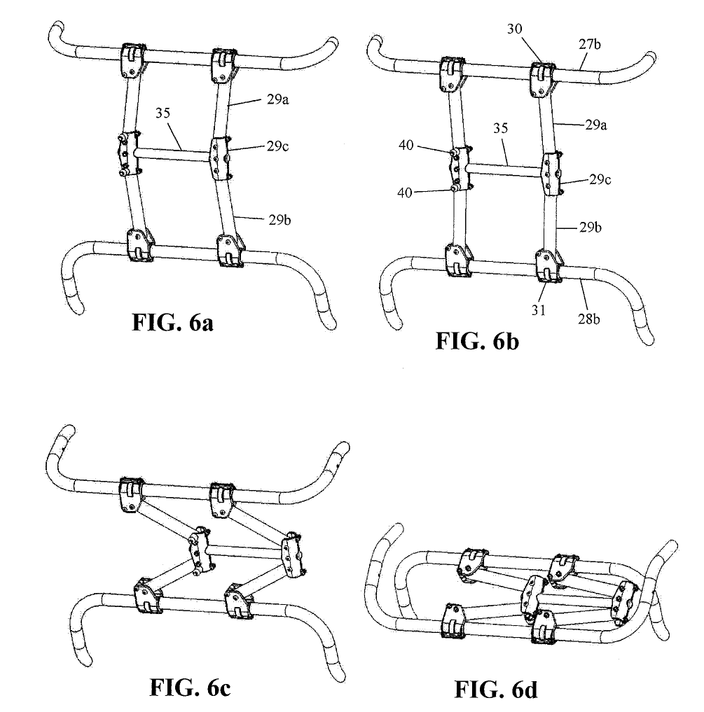

In addition, in FIGS. 7a, 7b, 7c and 7d (showing perspective, side, back and top views of a collapsed (folded) vehicle 26 of FIG. 2a), the support frame units 29 do not interfere with the cargo compartment or extend outside the perimeter of the folded upper frame 27 and base frame 28.

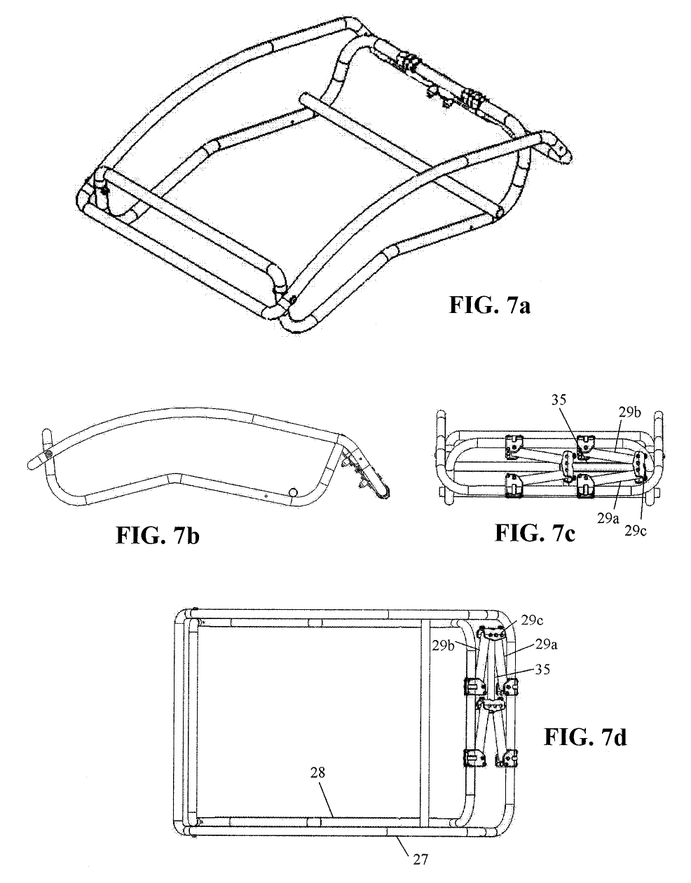

FIG. 8a illustrates another embodiment in which the LTV 100 has a single support frame unit 96 with first support member 96a, opposite support member 96b and folding connector 96c and connection brackets 97 and 98. FIGS. 8b, 8c and 8d show partial perspective views of the back of vehicle 100 of FIG. 8a and first support member 96a, opposite support member 96b, folding connector 96c, connection brackets 97 and 98. FIG. 8c shows a catch 99 in connection bracket 97 and a corresponding receptacle 101 in opposite frame member 96b. Catch and receptacle 99 and 101 are aligned when support frame unit 96 is in the extended position. The alignment of openings 99 and 101 allows for the insertion of a pin to secure against collapsing of support frame unit 96. FIG. 8b shows first support member 96a, opposite support member 96b and folding connector 96c in the extended position. The start of the collapsing process is illustrated in FIG. 8c. FIG. 8d shows first support member 96a, opposite support member 96b and folding connector 96c when vehicle 100 is partially collapsed. FIG. 8e shows first support member 96a, opposite support member 96b and folding connector 96c when vehicle 100 is collapsed.

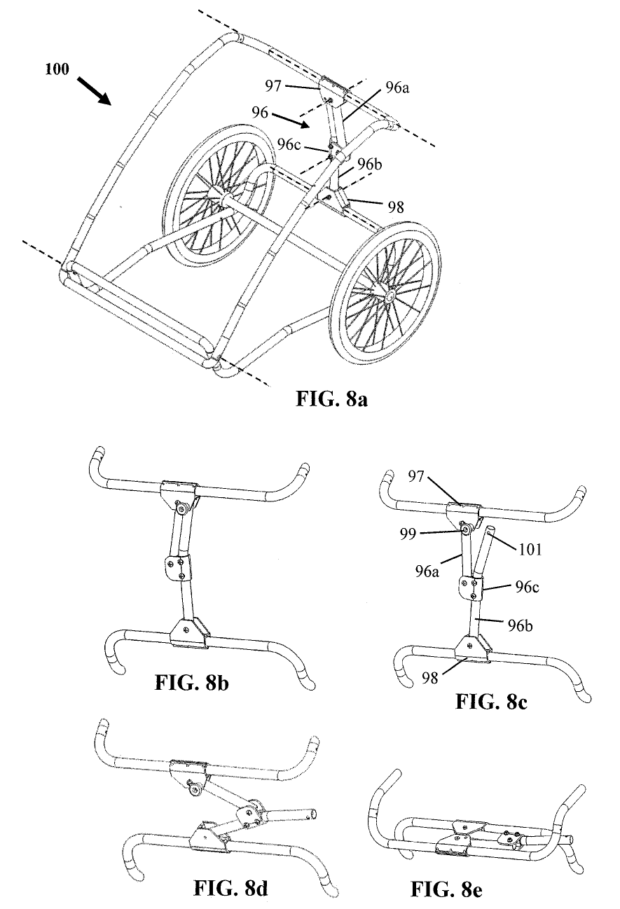

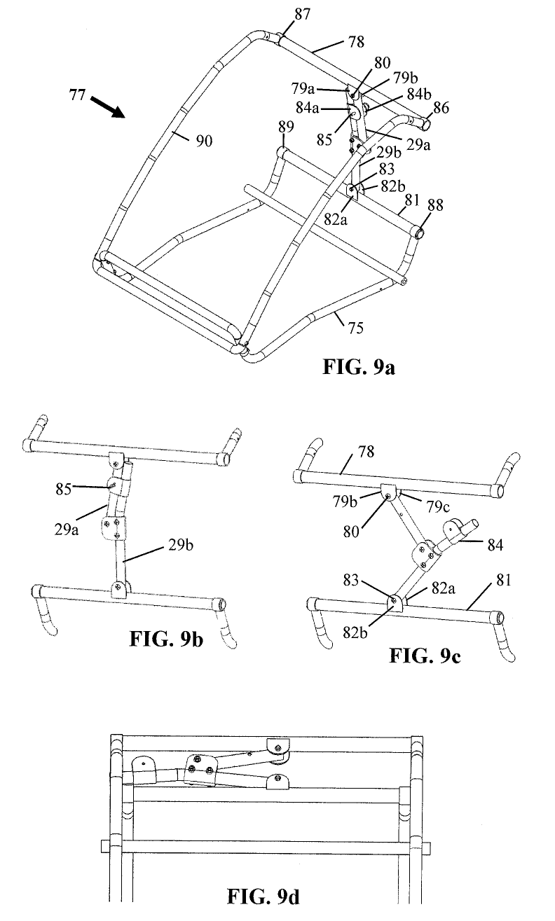

FIG. 9a shows a perspective view of vehicle 77 of a further embodiment. In this embodiment, the connection brackets 30 and 31 are replaced by rotation members 78 and 81. Rotation member 78 is connected to upper frame members 90 at connections 86 and 87. Rotation member 81 is connected to base frame 75 at connection 88 and 89. Rotation member 78 has two parallel extensions 79a and 79b with a connection 80 through both extensions 79a and 79b. Connection 80 allows first support member 29a to rotate in relation to rotation member 78. Rotation member 81 has two parallel extensions 82a and 82b with a connection 83 through both extensions 82a and 82b. Connection 83 allows opposite support member 29b to rotate in relation to rotation member 81. Opposite support member 29b has two parallel extensions 84a and 84b with an aperture through both extensions 84a and 84b. The aperture in extensions 84a and 84b aligns with an aperture through first support member 29a when vehicle 77 is in fully extended position. A releasable securing pin 85 is engaged through the aperture in extensions 84a and 84b and the aperture through first support member 29a to maintain vehicle 77 in the fully extended position.

FIGS. 9b, 9c and 9d show a partial view of vehicle 77 in FIG. 9a. FIG. 9b shows support members 29a and 29b in the extended position with securing pin 85 engaged. FIG. 9c shows the back of vehicle 77 when partially collapsed and FIG. 9d shows the collapsed orientation.

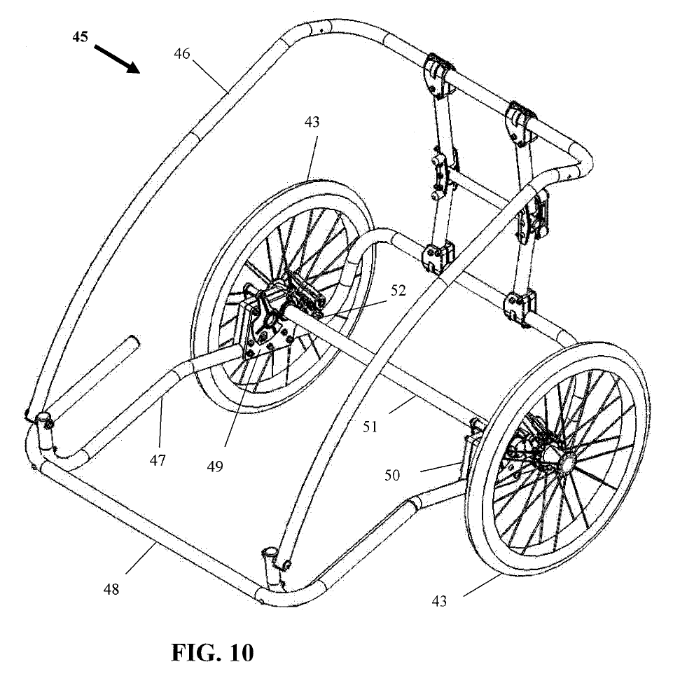

FIG. 10 illustrates a further embodiment. In this embodiment, vehicle 45 has an upper frame 46 that is substantially U-shaped and is open on its front end, and base frame formed of two members 47 and 48 that are connected adjacent to member 47 front ends. Vehicle 45 further comprises a suspension system 49 and 50 mounted onto member 47. Each suspension system can accept wheel axle 52 and absorb shocks from wheels 43 and reduce their effect on vehicle 45. Each suspension may be further stabilized by adding cross member 51 that connects the suspension systems together. The suspension system is described in greater detail below.

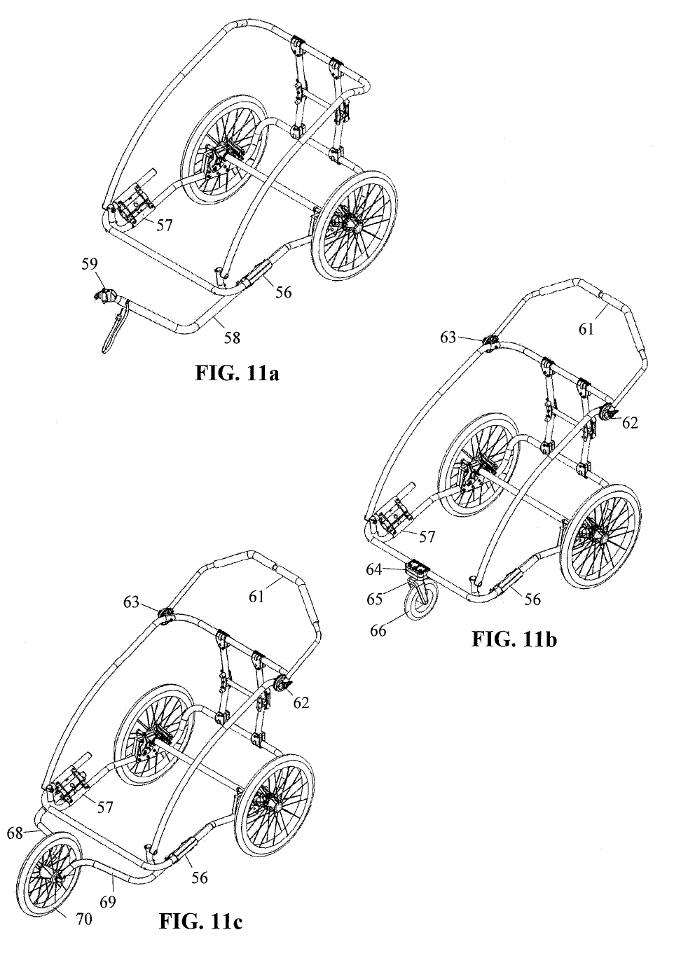

In FIG. 11a, vehicle 45 of FIG. 10 is shown with two attachment receivers 56 (described in greater detail below) and 57, tow bar 58 and hitch 59. In this configuration, the vehicle is useful as a bicycle trailer.

In FIG. 11b, vehicle 45 of FIG. 10 is shown with the addition of two attachment receivers 56 and 57, one caster receiver 64, pushing handle 61, pushing handle brackets 62 and 63, caster 65 and caster wheel 66. In this configuration, the vehicle is useful as a stroller.

In FIG. 11c, vehicle 45 of FIG. 10 is shown with the addition of two attachment receivers 56 and 57, pushing handle 61, pushing handle brackets 62 and 63, wheel arms 68 and 69 and wheel 70. In this configuration, the vehicle is useful as a jogger stroller (for fast walking or running).

In FIG. 11d, an embodiment is shown with the addition of two attachment receivers 56 and 57, tow bars 72 and 73 in which wheels are replaced with skis 74. In this configuration, the vehicle is useful as a sled.

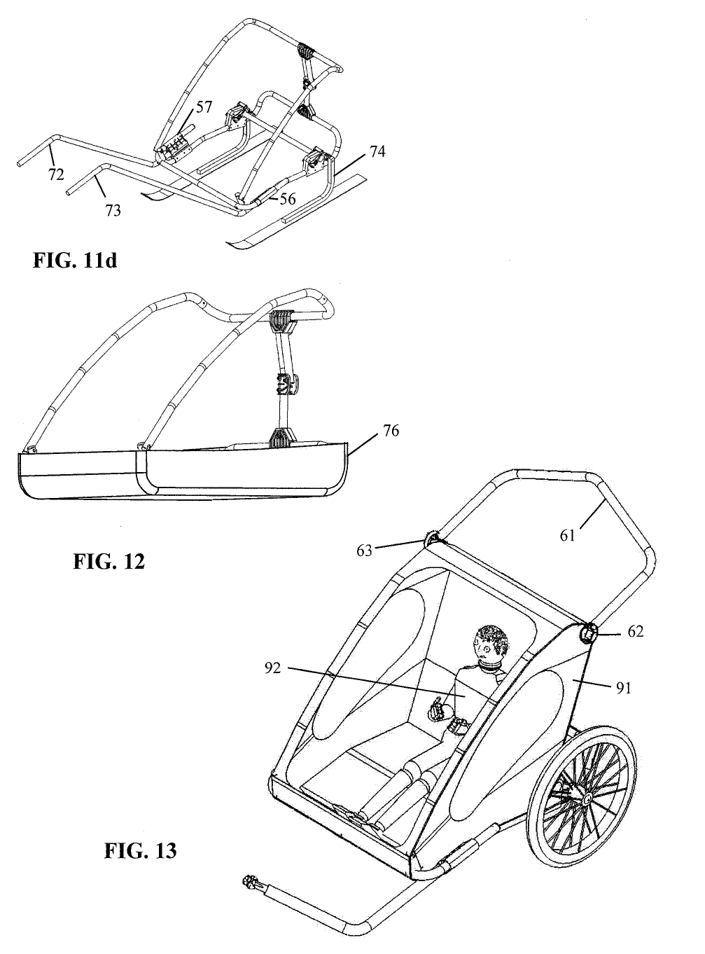

In FIG. 12, an embodiment is shown where the base frame is substantially formed of a plastic base 76. In this embodiment, the plastic base may provide protection to the occupants and to the vehicle components when folded.

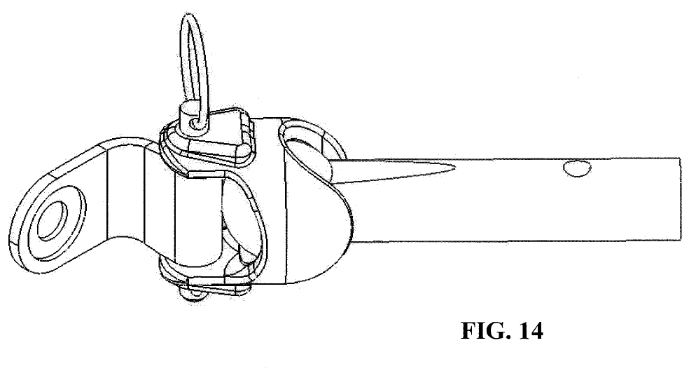

In FIG. 13, the vehicle of FIG. 8 is shown with the addition of pushing handle 61, pushing handle brackets 62 and 63, compartment cover 91 and passenger 92.

### OTHER EMBODIMENTS

As described above, FIGS. 2 to 13 show folding connectors 29c and 96c with pivot connections to facilitate the function of the folding connector (collapsing of support frame units 29 and 96). Folding connector 600, shown in FIGS. 4a to 4d, could replace folding connectors 29c and 96c (in FIGS. 2 to 13) and provide the same function.

Frame members and brackets in FIGS. 2 to 13 may be constructed of any suitable materials such as aluminum, steel, plastic or any other suitable material which provide adequate strength and durability. Shapes include tubing, solid rods, sheets or other suitable shapes. Connections including 32a, 32b, 32c, 32d, 34a, 34b, 80 and 83 may be any suitable means such as screws, bolts, pins or rivets. The connections should be durable, capable of repeated use and able to withstand stress. Possible forming processes include (but are not limited to): bending, mold injection, casting, fusing and pressure forming.

### Hitch

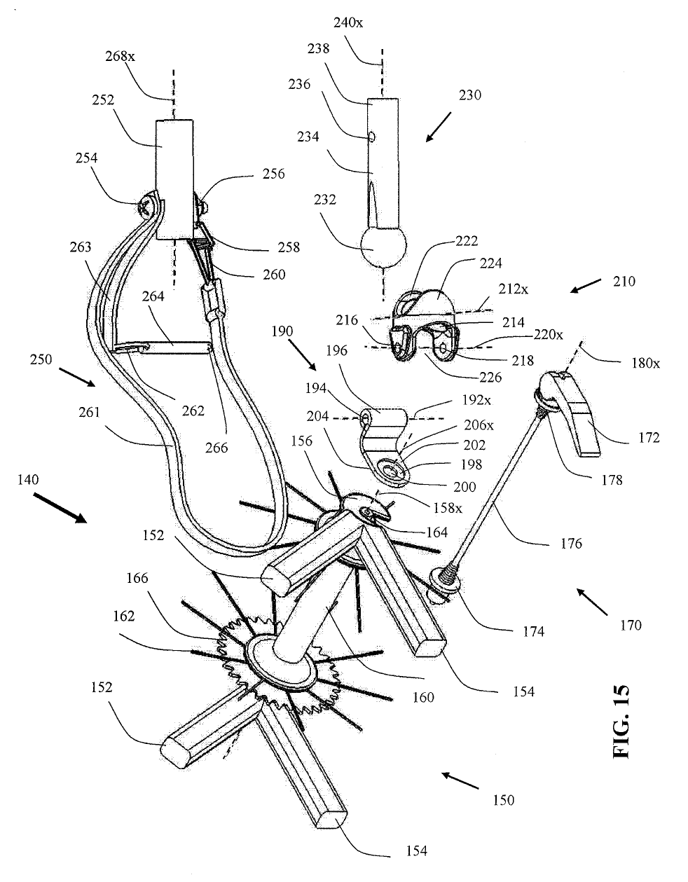

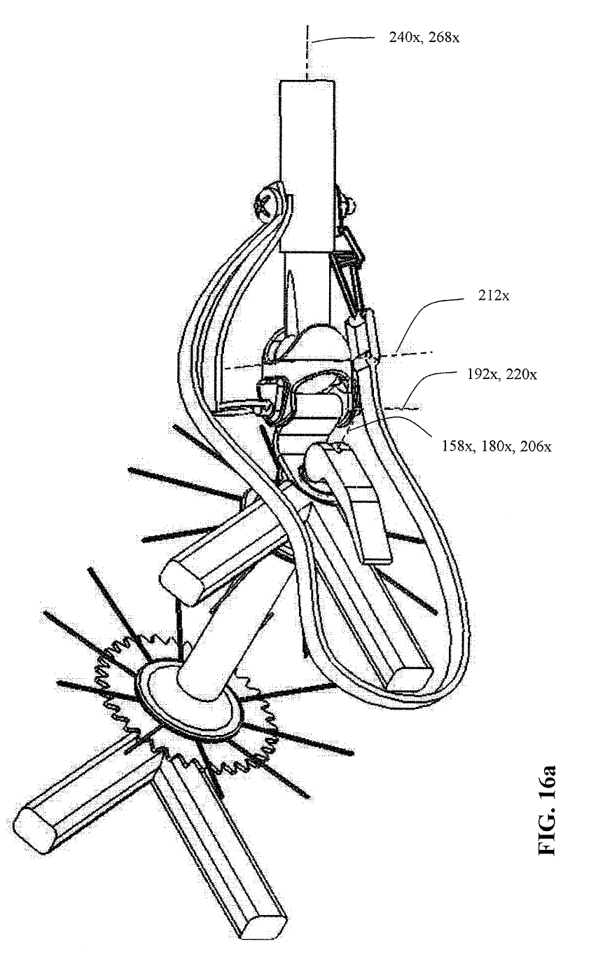

In FIG. 14 to FIG. 17b, a hitch is described. FIG. 14 shows a perspective view of a hitch, FIGS. 15 to 17b show exploded, assembled, plan, end and side views of hitch components and relevant bicycle components and a front end of a tow bar.

As shown in FIG. 15, a bicycle on which the hitch can be used has a rear end 150 comprising a frame with a pair of chain stays 154, a pair of seat stays 152 and a pair of drop-out brackets 156 that allow for mounting of a wheel to the bicycle. The rear wheel has hub 160, spokes 162, sprocket 166 and axle 164 extending through hub 160 and defining the wheel axis of rotation 158x. Quick release axle 170 may be used to retain the wheel within and against drop-out brackets 156. Quick release axle 170 includes axle rod 176 which is insertable through wheel axle 164 and is secured at one end through nut 174 and at the other end through washer 178 and quick release lever 172.

While one bicycle rear end 150 is shown in FIG. 15, the hitch in accordance with the invention can be configured with different frame arrangements and wheel axles. While the figures show an axle mounted hitch, the bicycle mounted hitch portion may be mounted in different methods onto a bicycle frame. Such methods include but are not limited to: clamping, bolting, bracketing and strapping to the bicycle frame. Adapters or connectors may be added to facilitate the attachment of the bicycle mounted hitch onto a bicycle.

Hitch link 230 includes rear end 238, ball end 232 and intermediate portion 234 extending therebetween. Ball end 232 is substantially spherical in shape with a diameter larger than the thickness of intermediate portion 234. As shown, hitch link 230 is connectable to the tow bar of a bicycle trailer by inserting rear end 238 into hollow tow bar front end 252 and aligning aperture 236 (extending through hitch link 230) with a pair of apertures (not shown) on tow bar front end 252. To secure the connection between hitch link 230 and tow bar front end 252, fastener (such as bolt 254) can be inserted through the aligned tow bar apertures (not shown) and aperture 236 of hitch link 230, nut 256 secures bolt 254 in place. When hitch link 230 is installed into tow bar front end 252, axis 240x of hitch link 230 is substantially aligned with axis 268x of tow bar front end 252 and ball end 232 and intermediate portion 234 extend forward of tow bar front end 252. While the figures show an insertable hitch link 230 into tow bar front end 252, other methods can be used to connect the hitch link 230 to different tow bars. This may require adjustments to the rear end of the hitch link 230, an addition of an adapter or both.

In the illustrated embodiment, bicycle link 190 is an axle-mounted part and has a formed end 196 creating a through-aperture 194 and creating a pivot connection to hitch socket 210 about axis 192x. The other end of bicycle link 190 is substantially a plate, the plate has an aperture 200 perpendicular to plate face 202 and extending therethrough.

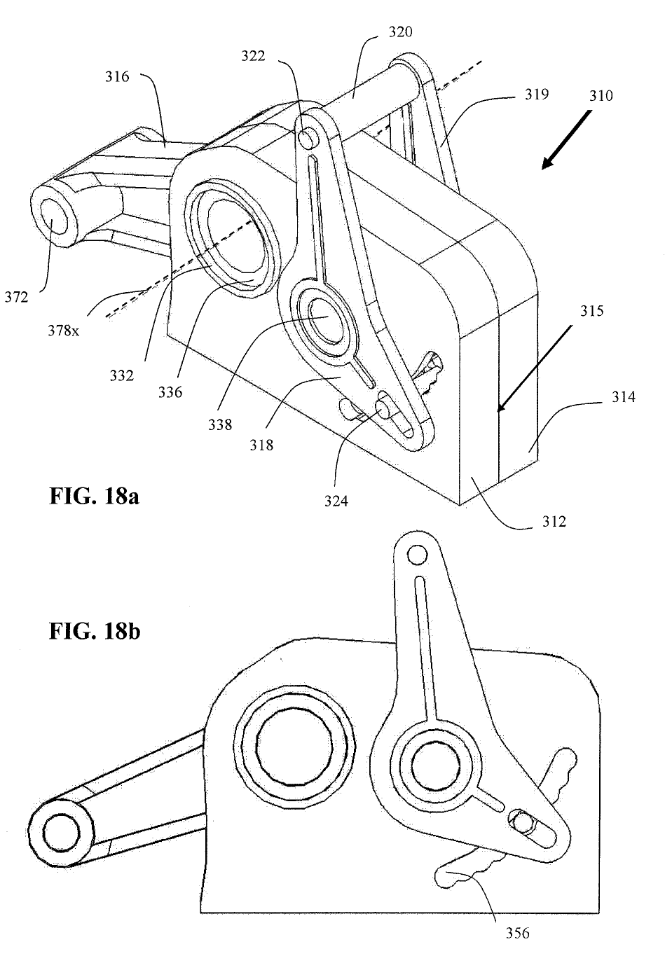

In a preferred embodiment, circular indentation 198 is formed on plate face 202 concentric to aperture 200. Indentation 198 is useful for centering the clamping feature, for example nut 270 (FIG. 17a) or washer 178 (FIG. 15), relative to aperture 200. Bicycle link 190 is preferably compact to reduce the effect on the appearance and size of the bicycle. Also, the compact size of bicycle link 190 minimizes the torque and stresses internal to bicycle link 190 and forces on the clamping assembly holding bicycle link 190 against drop-out bracket 156.

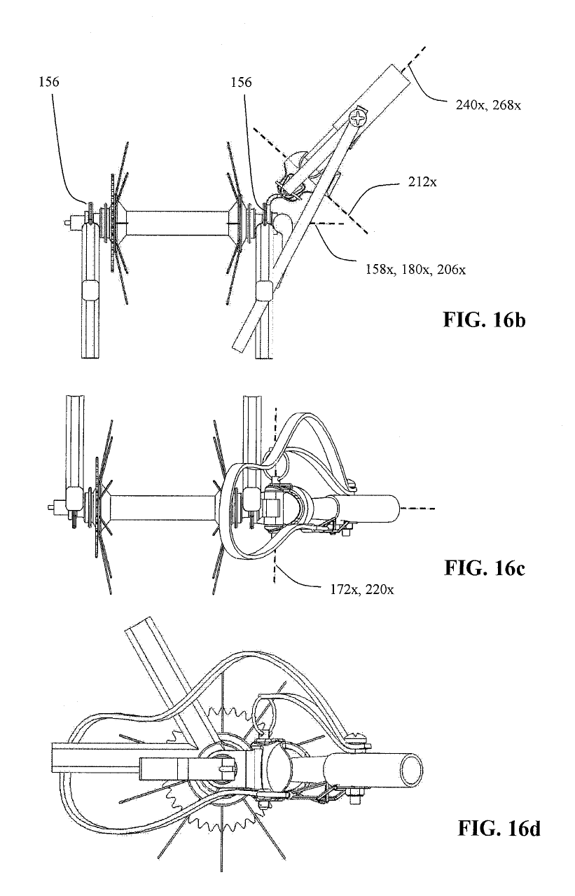

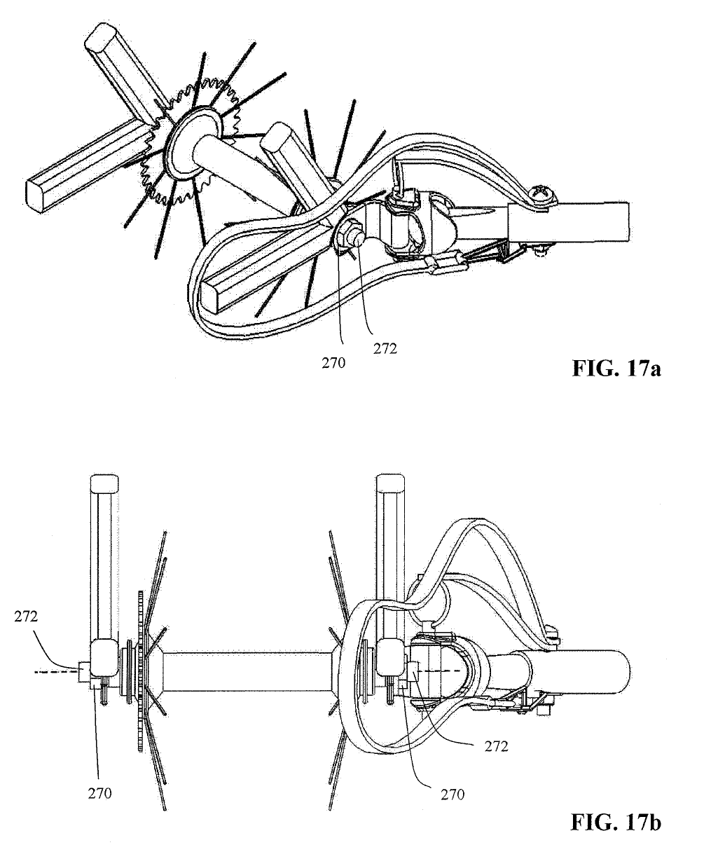

Hitch socket 210 includes open end 226 and retainer end 224. The hitch socket is formed to allow hitch link 230 to pass through open end 226 of hitch socket 210. Only rear end 238 and intermediate portion 234 of hitch link 230 can pass through slot 222 in retaining end 224 of hitch socket 210. The surface of ball end 232 of hitch link 230 comes in contact with the inner surface of retaining end 224 and seats thereon. Slot 222 and the inner surface of retaining end 224 are formed to permit the rotation of hitch link 230 about axis 240x (of hitch link 230) and rotation about axis 212x (of hitch socket 210—best illustrated in FIG. 16b) while blocking passage of ball end 232 through slot 222. Movement of hitch link 230 along slot 222 is limited by the abutment of intermediate portion 234 against hitch socket 210 material.

Further, open end 226 of hitch socket 210 is formed substantially U-shaped in the side view. An opening extends from the top face to the bottom face of the hitch socket 210 adjacent the open end 226 forming two apertures 216 and 218. Apertures 216 and 218 are useful for pivotally connecting hitch socket 210 to bicycle link 190, the connection can be made by positioning formed end 196 of bicycle link 190 intermediate between apertures 216 and 218, aligning axis 192x with axis 220x and inserting pin 264 into apertures 216, 194 and 218. Apertures 216 and 218 can be positioned on hitch socket 210 (with consideration of the diameter of ball end 232) such that when pin 264 is inserted into apertures 216, 194 and 218, ball end 232 is held closely between retaining end 224 of hitch socket 210 and formed end 196 of bicycle link 190. This minimizes linear movement of ball end 232 within hitch socket 210 thus reducing rattling and wear of ball end 232 and hitch socket 210.

Pivot connection of hitch socket 210 to bicycle link 190 allows for hitch socket 210 to pivot in relation to bicycle link 190 about axis 192x, hitch link 230 (inserted in hitch socket 210) also pivots (in relation to bicycle link 190) about axis 192x (in addition to axes 212x and 240x). It will be appreciated from the foregoing description that hitch link 230 can substantially pivot about three independent axes and non parallel, 240x, 212x and 192x, without the need for any flexure of intermediate portion 234 of hitch link 230.

Different types of fasteners can be used to pivotally connect bicycle link 190 to hitch socket 210. One example of a fastener pin is provided namely pin body 264 which has an aperture for attachment of ring 262. Ring 262 acts to prevent the top end of pin body 264 from passing through an aperture, the pin further includes spring raised detent ball 266 to prevent accidental release of the fastener pin. Strap 263 can be secured at its first end to ring 262 and to another position, such as to tow bar 252 through bolt 254 and nut 256, at its opposite end. Strap 263 is useful to prevent loss of fastener pin.

A safety strap is used to prevent separation of the trailer tow bar from the bicycle in the event any part of the hitch connection should come loose. The safety strap includes a strap 261, strap 261 can be secured at one end to tow bar 252 through bolt 254 and nut 256, the opposite end holds clip 260 for connection to D-ring 258 (also secured by bolt 254 and nut 256). Strap 261 can be extended about a strong part of the bicycle frame, for example chain stay or seat stay, and clipped onto D-ring 258 when the hitch is secured onto a bicycle.

When bicycle link 190 is mounted onto a bicycle, back face 204 of bicycle link 190 engages against drop-out bracket 156 and washer 178 of quick release 170 engages against the face of circular indentation 198. Also, axle 176 of quick release 170 extends through aperture 200, wheel hub 160 and extends beyond the outer face of the other drop-out bracket 156 for engagement of nut 174. When bicycle link 190 is mounted onto bicycle drop-out 156, axis 206x of bicycle link 190 is substantially in line with axis 158x through wheel hub 160. This allows for the use of the wheel axle to retain bicycle link 190 without modifications to the standard axle arrangement.

FIGS. 17a and 17b show hitch link 190 mounted onto drop-out bracket 156 by positioning bicycle link 190 such that the wheel's threaded axle 272 is inserted through aperture 200, nut 270 is tightened to secure bicycle link 190 against drop-out bracket 156.

Bicycle link 190 and hitch socket 210 are formed of durable, rigid and strong material such as different polymers or metal and may be formed (but are not limited to): bending, casting, injection molding and machining. A portion or the hitch link 230 can be formed of resilient material (to permit some flexion between the ball end and the rear end of the hitch link) such as different resilient polymers, rubber, spring or any other suitable material. Forming processes include (but are not limited to): casting, injection molding, machining and forming.

As will be appreciated from the foregoing, in order to use the hitch of the present invention, bicycle link 190 should be securely mounted onto a bicycle, hitch link 230 is positioned so that intermediate portion 234 extends through slot 222, ball end 232 is captured in socket retaining end 224 and then back end 238 of hitch link 230 is inserted into tow bar front end 252, aperture 236 through hitch link 230 is aligned with the apertures through tow bar front end 252 and secured by bolt 254 and nut 256. Pin strap 263, safety strap 261 and D-ring 258 are aligned and positioned to be secured by bolt 254 and nut 256 as well. The assembly of tow bar front end 252, hitch link 230 and hitch socket 210 is then brought toward bicycle link 190, hitch socket 210 is positioned such that formed end 196 of bicycle link 190 is situated in an intermediate position between aperture 216 and aperture 218 of hitch socket 210 and axis 192x is substantially aligned with axis 220x. Pin 264 is inserted into aperture 216, 194 and 218 until detent ball 266 completely protrudes beyond outer perimeter of aperture 218. Strap 261 can be wrapped around the bicycle frame and clip 260 engaged to D-ring 258. In addition, the tow bar should be securely attached to the trailer. In this way, the trailer is secured to the bicycle and ready for use.

### Suspension System

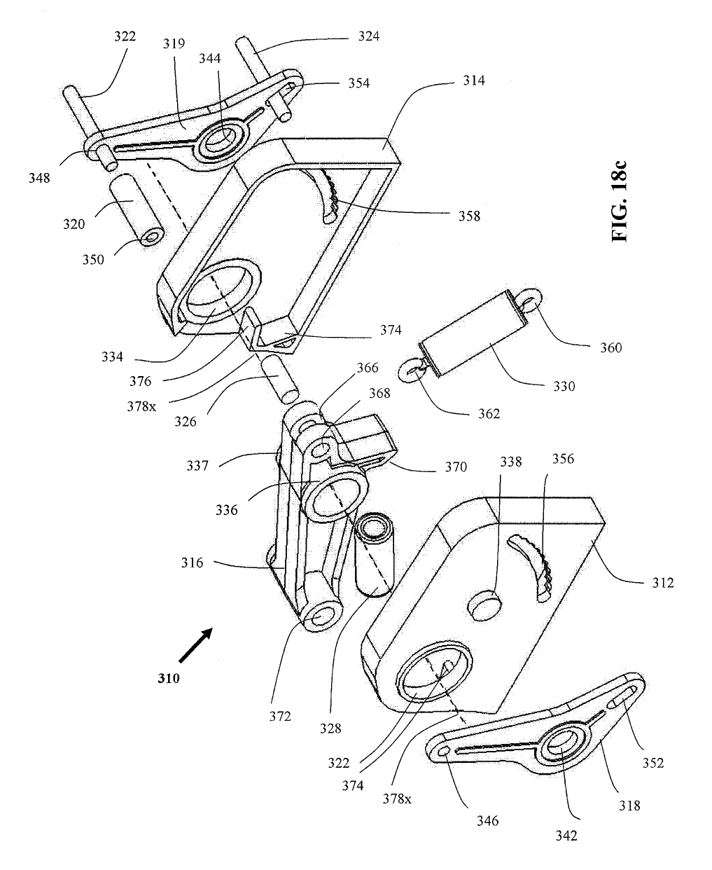

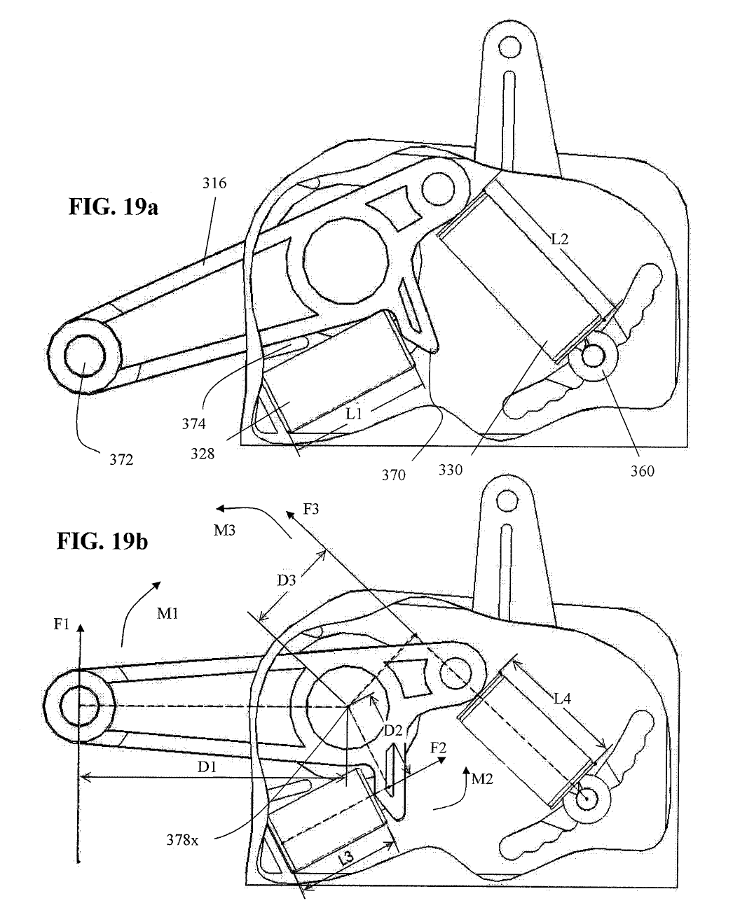

In FIGS. 18a to 21, a suspension system of the present invention is illustrated. FIGS. 18a, 18b and 18c show an illustration of an embodiment of suspension system 310 of the present invention. The illustrated suspension system 310 has first housing 312, second housing 314, pivot arm 316, adjustment levers 318 and 319, spacer 320, fastener 322, fastener 324, short pin 326, first resilient member 328 and second resilient member 330. First housing 312 and second housing 314 join together to form suspension housing 315, suspension housing 315 provide mounting features for the rest of the suspension system components. First housing 312 and second housing 314 can be secured together through snapping features, fasteners, fusing or any other suitable methods, not shown. Pivot arm 316 is installed into suspension housing 315 by positioning pivot arm 316 so that pivot boss 336 is inserted in pivot housing 332 and pivot boss 337 is inserted in pivot housing 334. Pivot bosses 336 and 337 are free to rotate inside pivot housings 332 and 334. Adjustment levers 318 and 319 are installed onto the suspension housing 315 by inserting pivot boss 338 into pivot housing 342 and inserting pivot boss of adjustment lever 319 into pivot housing 344. Spacer 320 is situated between adjustment levers 318 and 319. Aperture 350 of spacer 320 is aligned with aperture 346 of adjustment lever 318 and aperture 348 of adjustment lever 319 and fastener 322 is inserted to hold adjustment levers 318 and 319 and spacer 320 together. Fastener 322 can be in the form of bolt and nut, rivet or any other suitable form. Fastener 324 extends through slots 352 of adjustment lever 318, slot 356 of first housing 312, second loop end 360 of second resilient member 330, slot 358 of second housing 314 and slot 354 of adjustment levers 319. Fastener 324 is secured such that it does not move along it long axis but is free to rotate about its long axis, move along slots 352 and 354 of adjustment levers 318 and 319, and move along slots 356 and 358 of housings 312 and 314. Fastener 324 can be in the form of a bolt and nut, rivet or any other suitable form. First loop end 362 of second resilient member 330 is inserted in opening 366 of pivot arm 316, pin 326 is inserted through aperture 368 of pivot arm 316 and first loop end 362 to pivotally secure first loop end 362 to pivot arm 316. First resilient member 328 is installed such that when suspension system 310 is assembled, first resilient member 328 is captured between tab feature 370 of pivot arm 316 and walls of suspension housing 315 (FIG. 19a). Pivot arm 316 further comprises an aperture 372 for insertion of an axle to support wheels or other devices such as skis.

Suspension adjustment is required to compensate for load variation in the transport vehicle. In general, a stiffer suspension is desired when transporting a heavier load. FIGS. 19a and 19b illustrate the work mechanism of a suspension system of the present invention. FIGS. 19a and 19b are shown with a cut in first housing 312 to better illustrate the internal parts. FIG. 19a illustrates the suspension system 310 when no loads or impacts are applied. In this case, pivot arm 316 is pivoted so that pivot arm 316 is resting on walls 374 and 376 of housings 312 and 314. Aperture 372 is at its lowest position, first resilient member 328 is at its maximum installed length (L1) and second resilient member 330 is at its maximum installed length (L2). Length (L1) might be shorter than free length of the first resilient member 328 if pre loading is required in first resilient member 328 and length (L2) might be shorter than free length of second resilient member 330 if pre loading is required in second resilient member 330. FIG. 19a shows second loop end 360 of second resilient member 330 situated in an intermediate position between slots 356 and 358 of housings 312 and 314.

FIG. 19b illustrates suspension system 310 when a load or impact Fl is applied. In this case, the pivot arm 316 is pivoted upward and aperture 372 is raised from its lowest position and resilient members 328 and 330 are compressed. First resilient member 328 resists compression with force F2 and second resilient member 330 resists compression with force F3. Compression in resilient members 328 and 330 increase until force moments about pivot centre of pivot arm 316 (axis 378x) are balanced. At the balance position, the force moment M1 created by the load or impact F1, about pivot axis 378x, will be equal in value and opposite in direction to the sum of resistance force moments M2 and M3 (Resistance force moment M2 is created by resistance force F2 of resilient member 328, about pivot axis 378x, and resistance force moment M3 is created by resistance force F3 of second resilient member 330, about pivot axis 378x). As the value of F1 is decreased (by reducing the load or diminishing of the impact) M1 value will decrease, and M2 and M3 will cause the pivot arm to pivot downward and aperture 372 to lower until a new balance position is established.

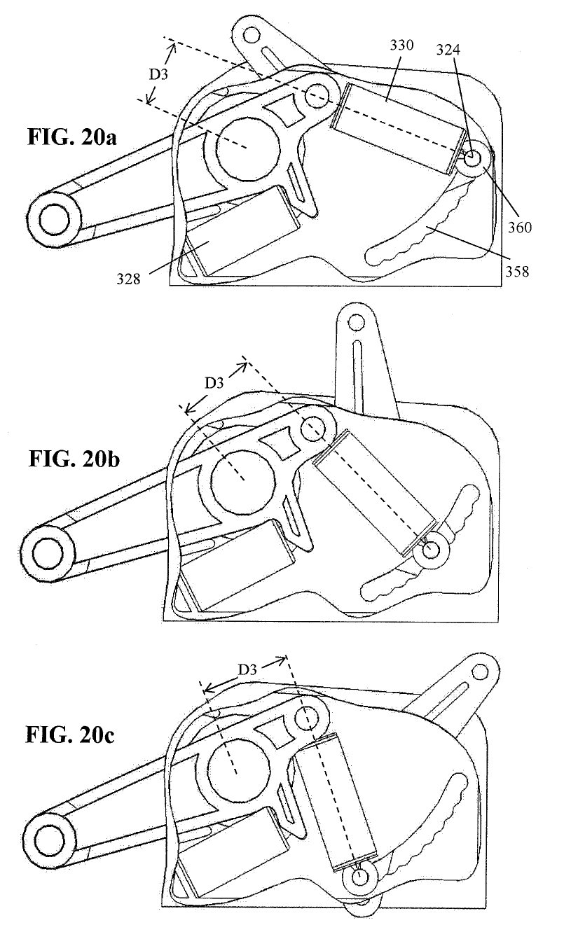

FIGS. 20a, 20b and 20c show three of the different adjustment of the suspension system 310. Adjustment is made by changing the location of second loop end 360. This location change is facilitated by sliding fastener 324, inserted through second loop end 360, along slots 356 and 358. FIG. 20a shows the softest adjustment. At this adjustment, second resilient member 330 will have the least resistance force moment M3 (least compression of second resilient member 330 per unit of rotation of pivot arm 316 and smallest offset D3), FIG. 20b shows an intermediate adjustment, at this adjustment, second resilient member 330 will have larger resistance force moment M3 than in FIG. 20a (larger compression of second resilient member 330 per unit of rotation of pivot arm 316 and larger offset D3) and FIG. 20c shows the stiffest adjustment, at this adjustment, second resilient member 330 will have the largest resistance force moment M3 (largest compression of second resilient member 330 per unit of rotation of pivot arm 316 and largest offset D3).

While the shown embodiment illustrates the suspension system 310 with two resilient members, the system can function with a single resilient member or more when resilient members are selected properly, if more than one resilient member is used, they can be identical or they can have different resistance, size or form. A resilient member can be formed of, or any combination of, mechanical spring, polymer, gas cylinder, pneumatic cylinder or hydraulic cylinder, or any other suitable members.

The shown embodiment illustrates resilient members that are utilized in compression. It should be understood that compression resilient members, tension resilient members, torsion resilient members or any combination of the preceding can be used in suspension system 310, mounting points and orientation of the resilient members will need to be adjusted to provide the intended function and performance.

Adjustment levers 318 and 319 are used to facilitate adjustment of suspension system 310. As spacer 320 is moved, adjustment levers 318 and 319 are pivoted about pivot boss 338 and 340. The slotted ends 352 and 354 move fastener 324 (inserted through second loop end 360) along slots 356 and 358 to the desired adjustment location. As shown in the illustrations, slots 356 and 358 are formed in such way to prevent accidental sliding of fastener 324.

As explained above, suspension systems are useful in absorbing impact and dampening vibration between the transport means and cargo support of a transport vehicle. The suspension system is intended to be used with light transport vehicles useful for transporting children, animals and/or cargo, such as a bicycle trailer, stroller, sled, or other vehicles. Suspension system 310 can be mounted onto a vehicle frame by various ways, including (but are not limited to): fusing, riveting, fastening and clamping.

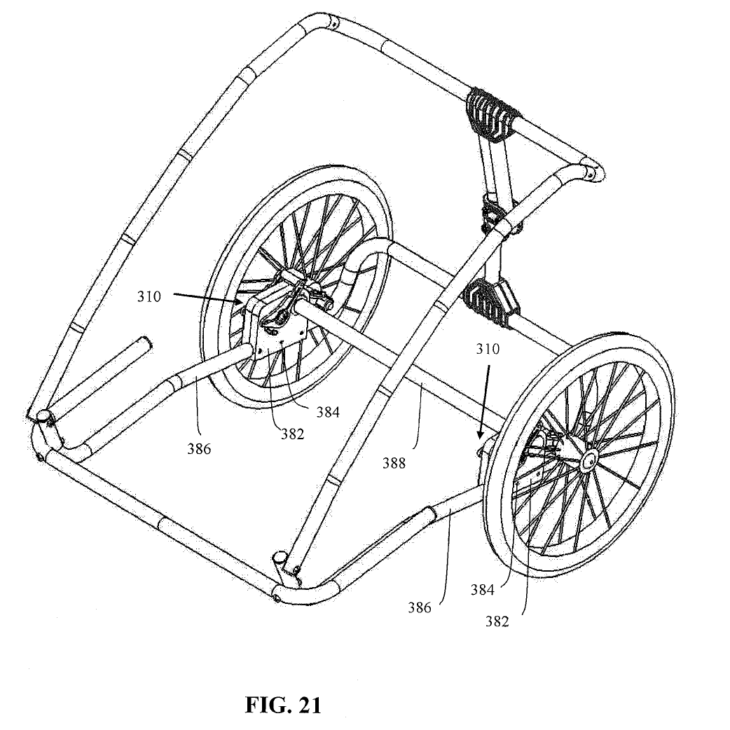

In FIG. 21, housings 312 and 314 have lower mounting extensions 382 with holes 384 through them so they can be bolted to frame member 386. While FIG. 21 shows two suspension systems 310 mounted onto the vehicle frame 386. One suspension system could be mounted in an intermediate position between the vehicles transport means or any other number of suspension systems in appropriate locations to provide the desired function and performance.

In the illustration of FIG. 21, an added cross bar 388 is extended between suspension systems 310. Cross bar 388 increases the stability of suspension systems 310 on vehicle frame 386 and can be mounted on any suitable location on the suspension system 310. It should be understood that while the presence of cross bar 388 is beneficial, it is not absolutely necessary.

Suspension housing 315, pivot arm 316 and adjustment levers 318 and 319 are formed of durable, rigid and strong material such as different polymers or metal. Forming processes include (but are not limited to): casting, injection molding, pressure forming and machining

### Attachment Anchor

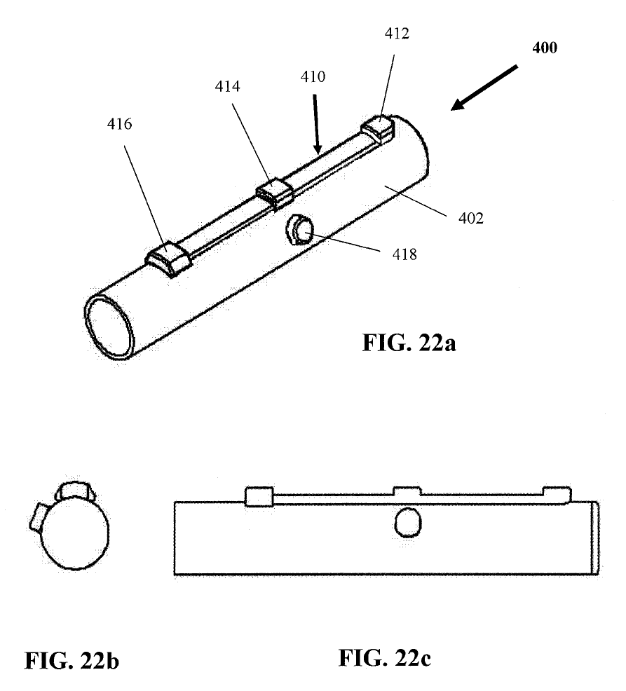

FIGS. 22a, 22b and 22c illustrate an embodiment of attachment anchor 400 useful for connecting conversion attachments to an LTV. Attachment anchor 400 can be an integral part of the conversion attachment or be connectable to the conversion attachment (FIG. 8 has the attachment anchor as an integral part of tow bar 58, FIG. 10 has the attachment anchor as an integral part of wheel arms 68 and 69 and FIG. 11 has the attachment anchor as an integral part of tow arm 72 and 73). The shown attachment anchor 400 has raised feature 410 useful for proper alignment of attachment anchor 400 while installed onto a transport vehicle. Raised feature 410 has a raised leading feature 412, raised intermediate feature 414 and raised limit feature 416. Raised features 412, 414 and 416 are useful for securing the attachment anchor 400 onto a transport vehicle. Attachment anchor 400 further comprises a spring button 418. When force is applied to the protruding portion of spring button 418, it submerges inside body 402 of attachment anchor 400 and when the force is decreased or eliminated, the spring button 418 moves toward its extended position, (protruding through body 402 of attachment anchor 400).

Although the illustrated embodiment of the attachment anchor 400 has only one raised feature 410, there are many possible shapes or configurations of raised features of the attachment anchors. For example, raised feature 410 could be formed as one piece with the body 402 or could be formed as an independent piece and then attached to the body 402. Attachment of an independent raised feature 410 to body 402 could be made through bolting, riveting, welding, gluing or other suitable process.

Although body 402 is shown to have a cylindrical shape, there are many suitable shapes that perform the intended function. Raised feature 410 and body 402 have to be made of strong rigid material to withstand stress and provide for reliable repeated use. Such material includes different types of metal and plastics and forming process include molding, casting, extruding, or other suitable processes.

### Attachment Receiver

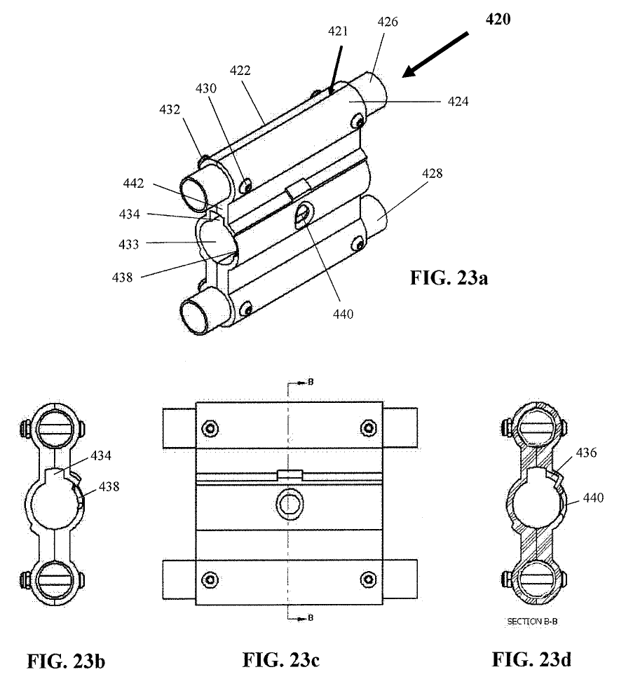

FIGS. 23a, 23b, 23c and 23d illustrate an embodiment of attachment receiver assembly 420. Attachment receiver housing 421 consists of first housing 422 and second housing 424. As first housing 422 and second housing 424 are assembled, the internal opening of attachment receiver housing 421 is formed. In the illustrated embodiment, attachment receiver housing 421 is assembled onto transport vehicle frame members 426 and 428 through the use of bolts 430 and nuts 432. The attachment receiver housing 421 has openings 433 and 434 to accept the insertion of attachment anchor 400 of FIG. 22a. Raised feature 410 has to be substantially aligned with opening 434 for the insertion (of attachment anchor 400 into the attachment receiver assembly 420). Attachment receiver housing 421 further comprises an enlarged opening 438 to facilitate the depression of spring button 418 of FIG. 22a as the attachment anchor 400 is inserted into the attachment receiver assembly 420.

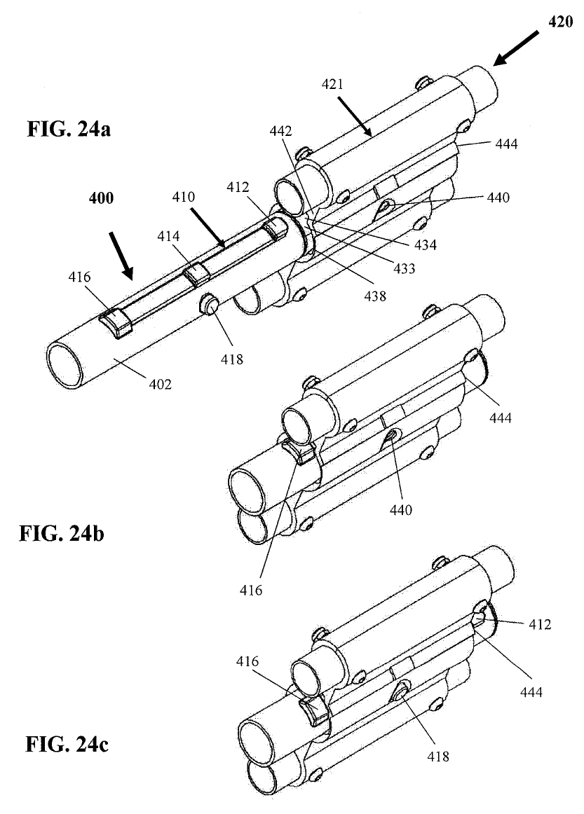

FIGS. 24a, 24b and 24c illustrate the attachment procedure of attachment anchor 400 into attachment receiver assembly 420. Dimensions of attachment anchor 400 and attachment housing 421 are selected such that main body 402 and raised feature 410 closely insert into opening 433 and opening 434 of attachment housing 421 (with the exception of limit feature 416 of raised feature 410).

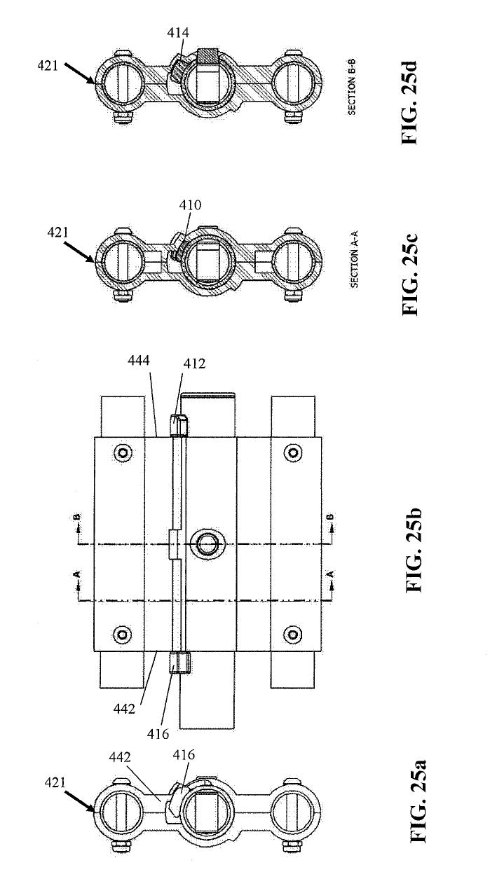

The selected dimensions allow for the insertion of attachment anchor 400 into attachment receiver assembly 420 until abutment of limit feature 416 against front face 442 of attachment receiver housing 421. At the abutment position, leading feature 412 exits completely through the rear face 444 of attachment receiver housing 421 and intermediate feature 414 aligns with internal slot 436 (best seen in FIG. 23d) of attachment receiver housing 421. The dimensions of intermediate feature 414 and internal slot 436 allow the intermediate feature 414 to closely travel along internal slot 436. At the insertion limit (abutment of limit feature 416 against front face 442), the attachment anchor 400 can be rotated inside attachment receiver housing 421 such that intermediate feature 414 travels along internal slot 436, limit feature 416 travels on front face 442 and leading feature 412 travels on rear face 444. This rotation is feasible until abutment of raised feature 410 against attachment receiver housing 421 (best seen in FIG. 25c and FIG. 25d).

At the described rotation limit, spring button 418 aligns with opening 440 in attachment receiver housing 421 and extends therethrough. The extension of spring button 418 through opening 440 prevents the attachment anchor 400 from rotating inside attachment receiver assembly 420 thus maintaining the attachment anchor 400 in the preferred operating position.

The rotation of attachment anchor 400 in receiver assembly 420 causes misalignment between intermediate feature 414 and opening 434 and misalignment between leading feature 412 and opening 434. This misalignment prevents attachment anchor 400 from pulling out of receiver assembly 420 and provides for a strong connection.

FIGS. 25a, 25b, 25c and 25d show front, side and two sectional views of the attachment anchor 400 while fully engaged into the attachment receiver assembly 420. FIG. 25b shows the location of leading feature 412 and limit feature 416 at the full engagement orientation and FIG. 25c shows the abutment of raised feature 410 against attachment receiver housing 421. FIG. 25d shows the abutment of intermediate feature 414 against attachment receiver housing 421.

### Caster Receiver

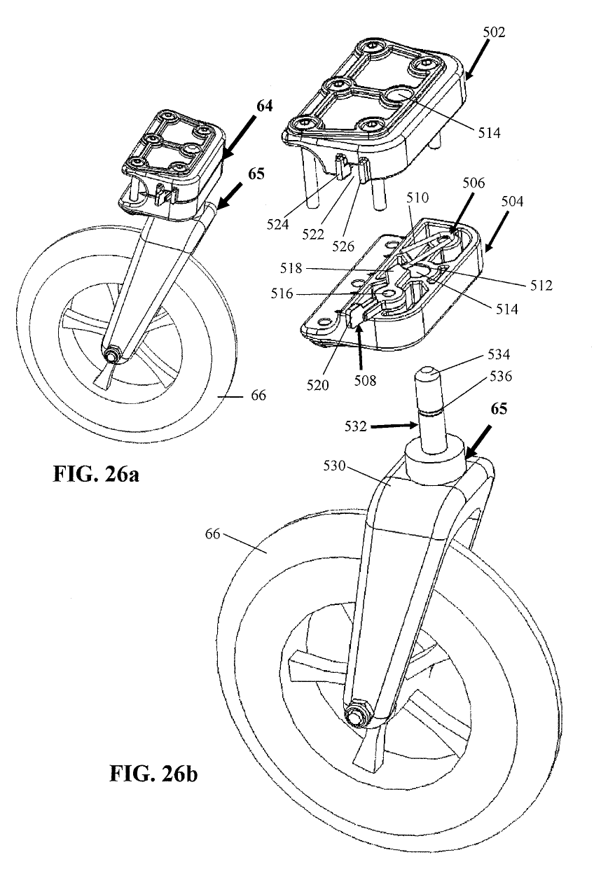

FIGS. 26a and 26b illustrate an embodiment of a caster receiver 64, stroller caster 65 and wheel 66 of the present invention. Caster receiver 64 has first housing 502, second housing 504, wire spring 506, lever actuator 508 and fasteners to hold the forgoing parts together. The assembly of first housing 502 and second housing 504 accommodates the installation of wire spring 506 and lever actuator 508. Lever actuator 508 has intermediate pivot feature 516 useful for pivoting about, spring activation end 518 useful for engagement with wire spring 506 and lever handle 520.

Lever handle 520 extends through opening 522 of first housing 502 (opening 522 limits the movement of lever handle 520 between first limit 524 and second limit 526). Wire spring 506 has first side 510 and second side 512 such that second side 512 is movable toward first side 510 under force and returns to an initial position when the force is eliminated. First side 510 (of wire spring 506) is butting against the body of housings 502 and 504 while second end 512 passes through aperture 514 (of housings 502 and 504). Second end 512 of wire spring 506 rests against spring activation end 518 (of lever actuator 508) such that it pushes lever handle 520 toward first limit 524 (of opening 522 in first housing 502). As lever handle 520 is moved toward second limit 226 (of opening 522 in first housing 502), spring activation end 518 pushes second side 512 (of wire spring 506) toward first side 510 (of wire spring 506). When lever handle 520 is at second limit 526 (of opening 522 in first housing 502), second side 512 (of wire spring 506) clears out of aperture 514 (of first housing 502 and second housing 504).

Stroller caster 65 has caster body 530 and mounting stem 532. Mounting stem 532 can be an integral part of caster body 530 or assembled thereon. Wheel 66 is assembled onto stroller caster 65 through the use of appropriate fasteners. Mounting stem 532 (of stroller caster 65) has a shape and size allowing for its insertion into aperture 514 (of first housing 502 and second housing 504). Mounting stem 532 (of stroller caster 65) has tapered top 534 useful for pushing second side 512 (of wire spring 506) out of aperture 514 (of first housing 502 and second housing 504) as mounting stem 532 is inserted into aperture 514 without the need to use lever actuator 508. Mounting stem 532 has groove 536 with a size and location such that when stroller caster 65 is in the preferred position for operation, groove 536 aligns with wire spring 506 allowing second side 512 (of wire spring 506) to move back toward its extended position. As second side 512 (of wire spring 506) moves toward its extended position, second side 512 engages into groove 536 (of mounting stem 532) and secures stroller caster 65 against pulling out of caster receiver 64. To remove stroller caster 65 out of caster receiver 64, lever handle 520 (of lever actuator 508) has to be moved toward second limit 526 (of opening 522 in first housing 502). As lever handle 520 (of lever actuator 508) is moved toward second limit 526, lever actuator 508 pivots about intermediate pivot feature 516 and spring activation end 518 depresses second side 512 (of wire spring 506) toward first end 510 (of wire spring 506) thus clearing second side 512 out of aperture 514 (of first housing 502 and second housing 504) and allowing for the removal of stroller caster 65 out of caster receiver 64.

In the preferred embodiment, caster receiver 64 is described having two housings 502 and 504. It is feasible to have a single housing or more to perform the intended function of the caster receiver. The locking feature of caster receiver 64 is described having wire spring 506 engaging groove 536 (of mounting stem 532). Other types of resilient members can be used to engage mounting stem 532 or drive a part that engages mounting stem 532. Groove 536 can be replaced by any suitable feature to allow engagement of the locking feature components with mounting stem 532.

In the preferred embodiment, assemblies are secured through bolts and nuts. It is clear that other methods can be used, these include (but are not limited to): fusing, riveting, fastening and clamping. All parts of caster receiver 64 and stroller caster 65 have to be made of strong rigid material to withstand stress and provide for reliable repeated use, such material includes different types of metal and plastics, forming process include machining, molding, casting, extruding, or other suitable processes.

1-24. (canceled)

25. A transport vehicle comprising:
a vehicle frame having a lower chassis supporting and pivotally connected to an upper frame adjacent front ends of the lower chassis and the upper frame respectively, the lower chassis operatively supporting a transportation apparatus;
first and second connection linkages operatively connected to rear end of the upper frame and rear end of the lower chassis respectively, wherein each of the connection linkages allows simultaneous movement about at least two non-parallel and non-intersecting axes, such that, one of the axis is rotatable about the other axis; and,
a support frame operably connected between the first and the second connection linkages, the support frame including an upper member and a lower member each having a first end and a second end; wherein:
the first ends are connected to one another via a folding connector allowing the upper support member to pivot toward the lower support member, and,
the second ends are each rotatably and pivotally connected to the upper frame and the lower chassis respectively via the connection linkages such that:
the second end of the lower member can both rotate about the lower chassis about a first axis and pivot relative to the lower chassis about a second axis; wherein the first and second axes are not parallel nor intersecting; and,
the second end of the upper member can both rotate about the upper frame about a third axis and pivot relative to the upper frame about a fourth axis; wherein the third and fourth axes are not parallel nor intersecting; such that
the upper frame and the lower chassis are displaceable between an extended position and a collapsed position, and the support frame folds in a lateral orientation with respect to the lower chassis and the upper frame.

26. A transport vehicle as in claim 25 wherein the rear ends of the upper frame and the lower chassis are displaceable past one another in the collapsed position such that the rear end of the upper frame is lower than the rear end of the lower chassis.

27. A transport vehicle as in claim 25 further comprising a second support frame and folding connector, third and fourth connections linkages and a cross member operatively connected to the first and the second support frames.

28. A transport vehicle as in claim 25 wherein the folding connector includes a biasing member for biasing the upper and the lower support members to an opening position.

29. A transport vehicle as in claim 25 wherein, in the collapsed position, the support frame is retained in a location between the rear end of the lower chassis and the rear end of the upper frame.

30. A transport vehicle as in claim 25 wherein, in the collapsed position, the support frame is positioned outside the border of the lower chassis.

31. A transport vehicle as in claim 25 wherein, in the collapsed position, the support frame is oriented such that the upper member is lower than the lower member and the rotation of the upper member away from the lower member drives the upper frame toward the lower chassis thus maintaining the vehicle frame in the collapsed position.

32. A transport vehicle as in claim 25 wherein the rear end of the lower chassis is raised to reduce the distance between the rear end of the upper frame and the rear end of the lower chassis thus reducing the height of the support frame and consequently reducing the collapsed size of the transport vehicle.

33. A transport vehicle hitch for operatively connecting a tow bar of a transport vehicle to a bicycle and enabling simultaneous rotation of the tow bar about three non-parallel axes in relation to the bicycle; the hitch comprising:
a hitch link including a rear end connectable to the tow bar, a front end formed as a ball and an intermediate portion extending therebetween; a hitch socket formed to retain the ball of the hitch link, the hitch socket having a front end; a rear end; a slot extending about the rear end of the hitch socket; and a first pivot connector, the front end of the hitch socket having an opening sized to permit the ball of the hitch link to pass therethrough and the rear end of the hitch socket is formed to retain the ball of the hitch link, wherein the assembly of the hitch link and the hitch socket enables pivotal movement of the hitch link in relation to the hitch socket about a first and second axes;
a bicycle link for attachment to a bicycle frame, the bicycle link including a second pivot connector releasably connectable to the first pivot connector allowing the hitch socket to pivot in relation to the bicycle link about a third axis.

34. A transport vehicle hitch as in claim 33 wherein the tow bar and the hitch link rotate, in relation to the bicycle link, about three substantially perpendicular axes without the need to flex the hitch link.

35. A transport vehicle hitch as in claim 33 wherein the first pivot connector and the second pivot connector are connected through a releasable retaining pin.

36. An adjustable suspension system for a transport vehicle having a vehicle frame and a transportation apparatus, the adjustable suspension system comprising:
a suspension body for operative connection to the vehicle frame; and,
a pivot arm pivotally connected to the suspension body, the pivot arm having:
i.- a first end for connection to the transportation apparatus; and,
ii- a first suspension connector for connection with a main suspension member, the main suspension member having:
a pivoting end for pivotal connection to the first suspension connector; and,
a sliding end for sliding support and engagement within an adjustment track within the suspension body;
the sliding end operatively connected to an adjustment lever for operative movement of the sliding end within the adjustment track;
wherein movement of the sliding end within the adjustment track changes the relative angle of the main suspension member with respect to the first suspension connector such that movement of the pivot arm with respect to the suspension body requires a different force depending on the relative angle of the main suspension member with respect to the first suspension connector.

37. An adjustable suspension system as in claim 36 wherein the pivot arm includes a second suspension connector for engagement with a non-adjustable suspension member operatively connected to the suspension body.

38. An adjustable suspension system as in claim 36 wherein the adjustable suspension system includes a connection system for operatively connecting two or more adjustable suspension systems together.

39. An attachment receiver for a transport vehicle having a vehicle frame, the attachment receiver for attachment to the vehicle frame and for releasably engaging an attachment frame member to the attachment receiver, the attachment receiver comprising: a body having a vehicle frame attachment system for securing the attachment receiver to the vehicle frame; and, at least one receiver orifice for securing the attachment frame member within the receiver orifice, the receiver orifice having a first interlocking system for receiving the attachment frame member to a first position and wherein twisting at the first position engages and secures a second interlocking system on the attachment frame member with the first interlocking system.
